(19) United States
(12) Patent Application Publication
(10) Pub. No.: US 2026/0281325 A1
(43) Pub. Date: Sep. 17, 2026

(54) Sampling of Search Region for Template Matching Prediction

(71) Applicant: Ofinno, LLC, Reston, VA (US)

(72) Inventor: Damian Ruiz Coll, Reston, VA (US)

(73) Assignee: Ofinno, LLC, Reston, VA (US)

(21) Appl. No.: 19/682,986

(22) Filed: May 20, 2026

Related U.S. Application Data
(63) Continuation of application No. PCT/US2024/057650, filed on Nov. 27, 2024.
(60) Provisional application No. 63/605,395, filed on Dec. 1, 2023.
(60) Provisional application No. 63/554,446, filed on Feb. 16, 2024.

(51) Int. Cl. H04N 19/105; H04N 19/132; H04N 19/176; H04N 19/50

(52) U.S. Cl. CPC H04N 19/105; H04N 19/132; H04N 19/176; H04N 19/50

(57) ABSTRACT

A video coder (encoder or decoder) determines a search region (SR) relative to a current block and determines, based on a sampling interval, a plurality of sampling positions in a plurality of sampling rows of the search region. Sampling positions of the plurality of sampling positions in two adjacent sampling rows of the plurality of sampling rows are in different columns of the search region. The coder further determines a plurality of template matching costs for a plurality of respective candidate reference blocks (RBs) at the plurality of respective sampling positions, determines an RB based on the plurality of template matching costs, and determines a prediction block of the current block based on the RB.

### CROSS-REFERENCE TO RELATED APPLICATIONS

This application is a continuation of International Application No. PCT/US2024/057650, filed Nov. 27, 2024, which claims the benefit of U.S. Provisional Application No. 63/605,395, filed Dec. 1, 2023, and U.S. Provisional Application No. 63/554,446, filed Feb. 16, 2024, all of which are hereby incorporated by reference in their entireties.

### BRIEF DESCRIPTION OF THE DRAWINGS

Some features are shown by way of example, and not by limitation, in the accompanying drawings. In the drawings, like numerals reference similar elements.

FIG. 1 shows an example video coding/decoding system in which embodiments of the present disclosure may be implemented.

FIG. 2 shows an example encoder in which embodiments of the present disclosure may be implemented.

FIG. 3 shows an example decoder in which embodiments of the present disclosure may be implemented.

FIG. 4 shows an example quadtree partitioning of a coding tree block (CTB).

FIG. 5 shows an example quadtree corresponding to the example quadtree partitioning of the CTB in FIG. 4.

FIG. 6 show examples of binary tree and ternary tree partitions.

FIG. 7 shows an example of combined quadtree and multi-type tree partitioning of a CTB.

FIG. 8 shows an example tree corresponding to the combined quadtree and multi-type tree partitioning of the CTB shown in FIG. 7.

FIG. 9 shows an example set of reference samples determined for intra prediction of a current block.

FIGS. 10A and 10B show example intra prediction modes.

FIG. 11 shows an example of a current block and corresponding reference samples.

FIG. 12 shows an example of applying an intra prediction mode (e.g., an angular mode) for prediction of a current block.

FIG. 13A shows an example of inter prediction performed for a current block in a current picture.

FIG. 13B shows an example motion vector.

FIG. 14 shows an example of bi-prediction performed for a current block.

FIG. 15A shows example spatial candidate neighboring blocks relative to a current block being coded.

FIG. 15B shows example locations of two temporal, co-located blocks relative to a current block.

FIG. 16 shows an example of intra block copy (IBC).

FIG. 17 illustrates an example of template matching prediction (TMP) for predicting a current block (CB), according to some embodiments.

FIG. 18 illustrates an example of template matching prediction (TMP) for predicting a current block (CB), according to some embodiments.

FIG. 19 illustrates an existing subsampling interval method for searching for a matching reference template.

FIG. 20 and FIG. 21 illustrate the shortcomings of the subsampling interval method described in FIG. 19.

FIG. 22 illustrates an example partial search region shown with a plurality of positions of candidate reference block that are arranged such that a sampling interval between two positions of candidate reference block in a diagonal line and a sampling interval between two positions of candidate reference block in a horizontal line are similar, according to some embodiments of the present disclosure.

FIG. 23A and FIG. 23B illustrate a plurality of positions of candidate reference blocks consistently spread (e.g., arranged uniformly, arranged evenly) over a plurality of search regions, according to some embodiments.

FIG. 23C illustrates a plurality of positions of candidate reference blocks consistently spread (e.g., arranged uniformly, arranged evenly) over a plurality of search regions without applying offsets, according to some embodiments.

FIG. 24A shows an example flowchart of method of determining a plurality of positions of candidate reference blocks such that the positions of candidate reference blocks are consistently spread (e.g., arranged uniformly, arranged evenly) over a plurality of search regions, according to some embodiments of the present disclosure.

FIG. 24B shows an example flowchart of method of arranging a plurality of positions of candidate reference blocks that are arranged such that a sampling interval between two positions of candidate reference blocks in a diagonal line and a sampling interval between two positions of candidate reference blocks in a horizontal line are similar, according to some embodiments of the present disclosure.

FIG. 24C shows an example flowchart of method of arranging a plurality of positions of candidate reference blocks as shown in FIG. 23C, according to some embodiments of the present disclosure.

FIG. 25 shows an example flowchart of method of determining a current block, according to some embodiments.

FIG. 26 shows an example flowchart of method of determining a current block, according to some embodiments.

FIG. 27 illustrates a block diagram of an example computer system in which embodiments of the present disclosure may be implemented.

### DETAILED DESCRIPTION

In the following description, numerous specific details are set forth in order to provide a thorough understanding of the disclosure. However, it will be apparent to those skilled in the art that the disclosure, including structures, systems, and methods, may be practiced without these specific details. The description and representation herein are the common means used by those experienced or skilled in the art to most effectively convey the substance of their work to others skilled in the art. In other instances, well-known methods, procedures, components, and circuitry have not been described in detail to avoid unnecessarily obscuring aspects of the disclosure.

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

Also, it is noted that individual embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in a figure. A process may correspond to a method, a function, a procedure, a subroutine, a subprogram, etc. When a process corresponds to a function, its termination can correspond to a return of the function to the calling function or the main function.

The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, memory or memory devices. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like.

Furthermore, embodiments may be implemented by hardware, software, firmware, middleware, microcode, hardware description languages, or any combination thereof. When implemented in software, firmware, middleware or microcode, the program code or code segments to perform the necessary tasks (e.g., a computer-program product) may be stored in a computer-readable or machine-readable medium. A processor(s) may perform the necessary tasks.

A video sequence, comprising multiple pictures/frames, may be represented in digital form for storage and/or transmission. Representing a video sequence in digital form may require a large quantity of bits. Large data sizes that may be associated with video sequences may require significant resources for storage and/or transmission. Video encoding may be used to compress a size of a video sequence for more efficient storage and/or transmission. Video decoding may be used to decompress a compressed video sequence for display and/or other forms of consumption.

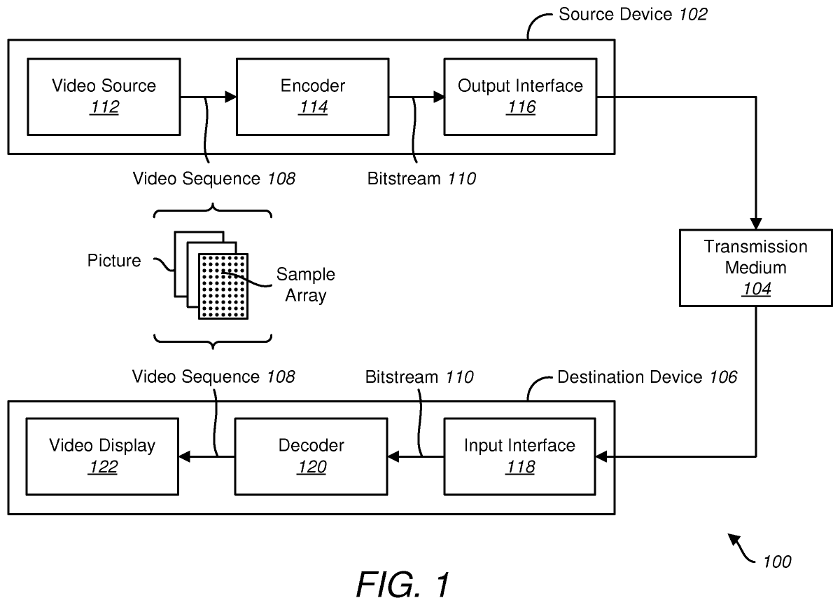

FIG. 1 shows an example video coding/decoding system 100 in which embodiments of the present disclosure may be implemented. Video coding/decoding system 100 comprises a source device 102, a transmission medium 104, and a destination device 106. Source device 102 encodes a video sequence 108 into a bitstream 110 for more efficient storage and/or transmission. Source device 102 may store and/or send/transmit bitstream 110 to destination device 106 via transmission medium 104. Destination device 106 decodes bitstream 110 to display video sequence 108. Destination device 106 may receive bitstream 110 from source device 102 via transmission medium 104. Source device 102 and/or destination device 106 may be any of a plurality of different devices (e.g., a desktop computer, laptop computer, tablet computer, smart phone, wearable device, television, camera, video gaming console, set-top box, video streaming device, etc.).

Source device 102 may comprise (e.g., for encoding video sequence 108 into bitstream 110) one or more of a video source 112, an encoder 114, and/or an output interface 116. Video source 112 may provide and/or generate video sequence 108 based on a capture of a natural scene and/or a synthetically generated scene. A synthetically generated scene may be a scene comprising computer generated graphics and/or screen content. Video source 112 may comprise a video capture device (e.g., a video camera), a video archive comprising previously captured natural scenes and/or synthetically generated scenes, a video feed interface to receive captured natural scenes and/or synthetically generated scenes from a video content provider, and/or a processor to generate synthetic scenes.

A video sequence, such as video sequence 108, may comprise a series of pictures (also referred to as frames). A video sequence may achieve an impression of motion based on successive presentation of pictures of the video sequence using a constant time interval or variable time intervals between the pictures. A picture may comprise one or more sample arrays of intensity values. The intensity values may be taken (e.g., measured, determined, provided) at a series of regularly spaced locations within a picture. A color picture may comprise (e.g., typically comprises) a luminance sample array and two chrominance sample arrays. The luminance sample array may comprise intensity values representing the brightness (e.g., luma component, Y) of a picture. The chrominance sample arrays may comprise intensity values that respectively represent the blue and red components of a picture (e.g., chroma components, Cb and Cr) separate from the brightness. Other color picture sample arrays may be possible based on different color schemes (e.g., a red, green, blue (RGB) color scheme). A pixel, in a color picture, may refer to/comprise/be associated with all intensity values (e.g., luma component, chroma components), for a given location, in the sample arrays (e.g., three sample arrays are used for one luma component and two chroma components, respectively) used to represent color pictures. A monochrome picture may comprise a single, luminance sample array. A pixel, in a monochrome picture, may refer to/comprise/be associated with the intensity value (e.g., luma component) at a given location in the single, luminance sample array used to represent monochrome pictures.

Encoder 114 may encode video sequence 108 into bitstream 110. Encoder 114 may apply/use (e.g., to encode video sequence 108) one or more prediction techniques to reduce redundant information in video sequence 108. Redundant information is information that may be predicted at a decoder and need not be transmitted to the decoder for accurate decoding of video sequence 108. For example, encoder 114 may apply spatial prediction (e.g., intra-frame or intra prediction), temporal prediction (e.g., inter-frame prediction or inter prediction), inter-layer prediction, and/or other prediction techniques to reduce redundant information in video sequence 108. Encoder 114 may partition pictures comprising video sequence 108 into rectangular regions referred to as blocks, for example, before applying one or more prediction techniques. Encoder 114 may then encode a block using the one or more of the prediction techniques.

For temporal prediction, encoder 114 may search for a block similar to the block being encoded in another picture (e.g., referred to as a reference picture) of video sequence 108. The block determined during the search (e.g., referred to as a prediction block) may then be used to predict the block being encoded. For spatial prediction, encoder 114 may form a prediction block based on data from reconstructed neighboring samples of the block to be encoded within the same picture of video sequence 108. A reconstructed sample refers to a sample that was encoded and then decoded. Encoder 114 may determine a prediction error (e.g., also referred to as a residual) based on the difference between a block being encoded and a prediction block. The prediction error may represent non-redundant information that may be sent/transmitted to a decoder for accurate decoding of video sequence 108.

Encoder 114 may apply a transform to the prediction error (e.g., using a discrete cosine transform (DCT), or any other transform) to generate transform coefficients. Encoder 114 may form bitstream 110 based on the transform coefficients and other information used to determine prediction blocks using/based on prediction types, motion vectors, and/or prediction modes. Encoder 114 may perform one or more of quantization and entropy coding of the transform coefficients and/or the other information used to determine the prediction blocks, for example, before forming bitstream 110. The quantization and/or the entropy coding may further reduce the quantity of bits needed to store and/or transmit video sequence 108.

Output interface 116 may be configured to write and/or store bitstream 110 onto transmission medium 104 for transmission to destination device 106. In addition or alternatively, output interface 116 may be configured to send/transmit, upload, and/or stream bitstream 110 to destination device 106 via transmission medium 104. Output interface 116 may comprise a wired and/or a wireless transmitter configured to send/transmit, upload, and/or stream bitstream 110 in accordance with one or more proprietary, open-source, and/or standardized communication protocols (e.g., Digital Video Broadcasting (DVB) standards, Advanced Television Systems Committee (ATSC) standards, Integrated Services Digital Broadcasting (ISDB) standards, Data Over Cable Service Interface Specification (DOCSIS) standards, 3rd Generation Partnership Project (3GPP) standards, Institute of Electrical and Electronics Engineers (IEEE) standards, Internet Protocol (IP) standards, Wireless Application Protocol (WAP) standards, and/or any other communication protocol).

Transmission medium 104 may comprise wireless, wired, and/or computer readable medium. For example, transmission medium 104 may comprise one or more wires, cables, air interfaces, optical discs, flash memory, and/or magnetic memory. In addition or alternatively, transmission medium 104 may comprise one or more networks (e.g., the internet) or file servers configured to store and/or send/transmit encoded video data.

Destination device 106 may decode bitstream 110 into video sequence 108 for display. Destination device 106 may comprise one or more of an input interface 118, a decoder 120, and/or a video display 122. Input interface 118 may be configured to read bitstream 110 stored on transmission medium 104 by source device 102. In addition or alternatively, input interface 118 may be configured to receive, download, and/or stream bitstream 110 from source device 102 via transmission medium 104. Input interface 118 may comprise a wired and/or a wireless receiver configured to receive, download, and/or stream bitstream 110 in accordance with one or more proprietary, open-source, standardized communication protocols, and/or any other communication protocol (e.g., such as referenced herein). Decoder 120 may decode video sequence 108 from encoded bitstream 110. The decoder 120 may generate prediction blocks for pictures of video sequence 108 in a similar manner as encoder 114 and determine the prediction errors for the blocks, for example, to decode video sequence 108. Decoder 120 may generate the prediction blocks using/based on prediction types, prediction modes, and/or motion vectors received in bitstream 110. Decoder 120 may determine the prediction errors using the transform coefficients received in bitstream 110. Decoder 120 may determine the prediction errors by weighting transform basis functions using the transform coefficients. Decoder 120 may combine the prediction blocks and the prediction errors to decode video sequence 108. Video sequence 108 at the destination device 106 may be, or may not necessarily be, the same video sequence sent, such as video sequence 108 as sent by the source device 102. Decoder 120 may decode a video sequence that approximates video sequence 108, for example, because of lossy compression of video sequence 108 by encoder 114 and/or errors introduced into encoded bitstream 110 during transmission to destination device 106.

Video display 122 may display video sequence 108 to a user. Video display 122 may comprise a cathode rate tube (CRT) display, a liquid crystal display (LCD), a plasma display, a light emitting diode (LED) display, and/or any other display device suitable for displaying video sequence 108.

Video coding/decoding system 100 is merely an example and video encoding/decoding systems different from the video coding/decoding system 100 and/or modified versions of the video coding/decoding system 100 may similarly perform the methods and processes as described herein. For example, the video coding/decoding system 100 may comprise other components and/or arrangements. For example, video source 112 may be external to source device 102. Similarly, video display 122 may be external to destination device 106 or omitted altogether (e.g., if video sequence 108 is intended for consumption by a machine and/or storage device). In an example, source device 102 may further comprise a video decoder and destination device 106 may further comprise a video encoder. For example, source device 102 may be configured to further receive an encoded bitstream from destination device 106 to support two-way video transmission between the devices.

Encoder 114 and/or decoder 120 may operate according to one or more proprietary or industry video coding standards. For example, encoder 114 and/or decoder 120 may operate in accordance with one or more proprietary, open-source, and/or standardized protocols (e.g., International Telecommunications Union Telecommunication Standardization Sector (ITU-T) H.263, ITU-T H.264 and Moving Picture Expert Group (MPEG)-4 Visual (also known as Advanced Video Coding (AVC)), ITU-T H.265 and MPEG-H Part 2 (also known as High Efficiency Video Coding (HEVC)), ITU-T H.265 and MPEG-I Part 3 (also known as Versatile Video Coding (VVC), the WebM VP8 and VP9 codecs, and/or AOMedia Video 1 (AV1), and/or any other video coding protocol).

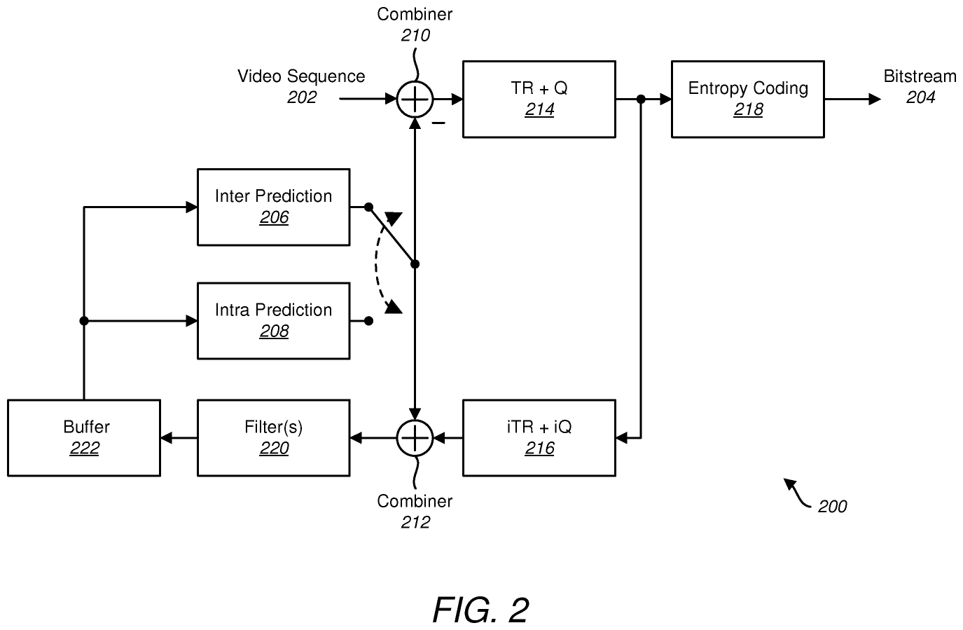

FIG. 2 shows an example encoder. Encoder 200 as shown in FIG. 2 may implement one or more processes described herein. Encoder 200 may encode a video sequence 202 into a bitstream 204 for more efficient storage and/or transmission. Encoder 200 may be implemented in video coding/decoding system 100 as shown in FIG. 1 (e.g., as encoder 114) or in any computing, communication, or electronic device (e.g., desktop computer, laptop computer, tablet computer, smart phone, wearable device, television, camera, video gaming console, set-top box, video streaming device, etc.). Encoder 200 may comprise one or more of an inter prediction unit 206, an intra prediction unit 208, combiners 210 and 212, a transform and quantization unit (TR+Q) 214, an inverse transform and quantization unit (iTR+iQ) 216, an entropy coding unit 218, one or more filters 220, and/or a buffer 222.

Encoder 200 may partition pictures (e.g., frames) of (e.g., comprising) video sequence 202 into blocks and encode video sequence 202 on a block-by-block basis. Encoder 200 may perform/apply a prediction technique on a block being encoded using either inter prediction unit 206 or intra prediction unit 208. Inter prediction unit 206 may perform inter prediction by searching for a block similar to the block being encoded in another, reconstructed picture (e.g., a reference picture) of video sequence 202. A reconstructed picture refers to a picture that was encoded and then decoded. The block determined during the search (e.g., referred to as a prediction block) may then be used to predict the block being encoded to remove redundant information. Inter prediction unit 206 may exploit temporal redundancy or similarities in scene content from picture to picture in video sequence 202 to determine the prediction block. For example, scene content between pictures of video sequence 202 may be similar except for differences due to motion and/or affine transformation of the screen content over time.

Intra prediction unit 208 may perform intra prediction by forming a prediction block based on data from reconstructed neighboring samples of the block to be encoded within the same picture of video sequence 202. A reconstructed sample refers to a sample that was encoded and then decoded. Intra prediction unit 208 may exploit spatial redundancy or similarities in scene content within a picture of video sequence 202 to determine the prediction block. For example, the texture of a region of scene content in a picture may be similar to the texture in the immediate surrounding area of the region of the scene content in the same picture.

Combiner 210 may determine a prediction error (e.g., referred to as a residual) based on the difference between the block being encoded and the prediction block. The prediction error may represent non-redundant information that may be sent/transmitted to a decoder for accurate decoding of video sequence 202.

Transform and quantization unit (TR+Q) 214 may transform and quantize the prediction error. Transform and quantization unit 214 may transform the prediction error into transform coefficients by applying, for example, a DCT to reduce correlated information in the prediction error. Transform and quantization unit 214 may quantize the coefficients by mapping data of the transform coefficients to a predefined set of representative values. Transform and quantization unit 214 may quantize the coefficients to reduce irrelevant information in bitstream 204. The irrelevant information refers to information that may be removed from the coefficients without producing visible and/or perceptible distortion in video sequence 202 after decoding (e.g., at a receiving device).

Entropy coding unit 218 may apply one or more entropy coding methods to the quantized transform coefficients to further reduce the bit rate. For example, entropy coding unit 218 may apply context adaptive variable length coding (CAVLC), context adaptive binary arithmetic coding (CABAC), and/or syntax-based context-based binary arithmetic coding (SBAC). The entropy coded coefficients may be packed to form bitstream 204.

Inverse transform and quantization unit (iTR+iQ) 216 may inverse quantize and inverse transform the quantized transform coefficients to determine a reconstructed prediction error. Combiner 212 may combine the reconstructed prediction error with the prediction block to form a reconstructed block. Filter(s) 220 may filter the reconstructed block, for example, using a deblocking filter and/or a sample-adaptive offset (SAO) filter. Buffer 222 may store the reconstructed block for prediction of one or more other blocks in the same and/or different picture of video sequence 202.

Encoder 200 may further comprise an encoder control unit. The encoder control unit may be configured to control one or more units of encoder 200 as shown in FIG. 2. The encoder control unit may control the one or more units of encoder 200 such that bitstream 204 may be generated in conformance with the requirements of one or more proprietary coding protocols, industry video coding standards, and/or any other video cording protocol. For example, the encoder control unit may control the one or more units of encoder 200 such that bitstream 204 may be generated in conformance with one or more of ITU-T H.263, AVC, HEVC, VVC, VP8, VP9, AV1, and/or any other video coding standard/format.

The encoder control unit may be configured to attempt to minimize (or reduce) the bitrate of bitstream 204 and/or maximize (or increase) the reconstructed video quality (e.g., within the constraints of a proprietary coding protocol, industry video coding standard, and/or any other video cording protocol). For example, the encoder control unit may be configured to attempt to minimize or reduce the bitrate of bitstream 204 such that the reconstructed video quality does not fall below a certain level/threshold, and/or to maximize or increase the reconstructed video quality such that the bitrate of bitstream 204 does not exceed a certain level/threshold. The encoder control unit may determine/control one or more of: partitioning of the pictures of video sequence 202 into blocks, whether a block is inter predicted by inter prediction unit 206 or intra predicted by intra prediction unit 208, a motion vector for inter prediction of a block, an intra prediction mode among a plurality of intra prediction modes for intra prediction of a block, filtering performed by filter(s) 220, and/or one or more transform types and/or quantization parameters applied by transform and quantization unit 214. The encoder control unit may determine/control one or more of the above based on a rate-distortion measure for a block or picture being encoded. The encoder control unit may determine/control one or more of the above to reduce the rate-distortion measure for a block or picture being encoded.

The prediction type used to encode a block (intra or inter prediction), prediction information of the block (intra prediction mode if intra predicted, motion vector, etc.), and/or transform and/or quantization parameters, may be sent to entropy coding unit 218 to be further compressed (e.g., to reduce the bitrate). For example, entropy coding unit 218 may apply context adaptive variable length coding (CAVLC), context adaptive binary arithmetic coding (CABAC), and/or syntax-based context-based binary arithmetic coding (SBAC) to achieve further compression. The prediction type, prediction information, and/or transform and/or quantization parameters may be packed with the prediction error to form bitstream 204.

Encoder 200 is merely an example and encoders different from encoder 200 and/or modified versions of encoder 200 may perform the methods and processes as described herein. For example, encoder 200 may comprise other components and/or arrangements. One or more of the components shown in FIG. 2 may be optionally included in encoder 200 (e.g., entropy coding unit 218 and/or filters(s) 220).

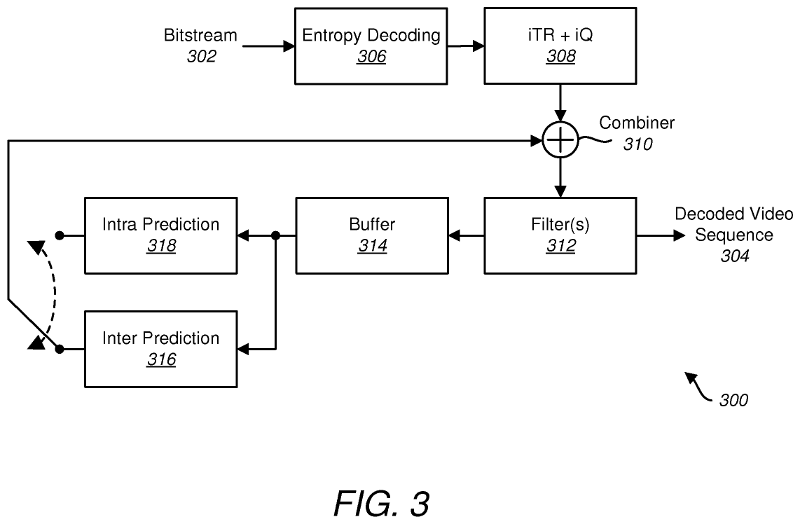

FIG. 3 shows an example decoder. A decoder 300 as shown in FIG. 3 may implement one or more processes described herein. Decoder 300 may decode a bitstream 302 into a decoded video sequence 304 for display and/or some other form of consumption. Decoder 300 may be implemented in video coding/decoding system 100 in FIG. 1 and/or in a computing, communication, or electronic device (e.g., desktop computer, laptop computer, tablet computer, smart phone, wearable device, television, camera, video gaming console, set-top box, and/or video streaming device). Decoder 300 may comprise an entropy decoding unit 306, an inverse transform and quantization (iTR+iQ) unit 308, a combiner 310, one or more filters 312, a buffer 314, an inter prediction unit 316, and/or an intra prediction unit 318. Decoder 300 may comprise a decoder control unit configured to control one or more units of decoder 300. The decoder control unit may control the one or more units of decoder 300 such that bitstream 302 is decoded in conformance with the requirements of one or more proprietary coding protocols, industry video coding standards, and/or any other communication protocol. For example, the decoder control unit may control the one or more units of decoder 300 such that the bitstream 302 is decoded in conformance with one or more of ITU-T H.263, AVC, HEVC, VVC, VP8, VP9, AV1, and/or any other video coding standard/format.

The decoder control unit may determine/control one or more of: whether a block is inter predicted by inter prediction unit 316 or intra predicted by intra prediction unit 318, a motion vector for inter prediction of a block, an intra prediction mode among a plurality of intra prediction modes for intra prediction of a block, filtering performed by filter(s) 312, and/or one or more inverse transform types and/or inverse quantization parameters to be applied by inverse transform and quantization unit 308. One or more of the control parameters used by the decoder control unit may be packed in bitstream 302.

Entropy decoding unit 306 may entropy decode the bitstream 302. For example, entropy decoding unit 306 may apply context adaptive variable length coding (CAVLC), context adaptive binary arithmetic coding (CABAC), and syntax-based context-based binary arithmetic coding (SBAC) to decompress the prediction type used to encode a block (intra or inter prediction), prediction information of the block (intra prediction mode if intra predicted, motion vector, etc.), and transform and quantization parameters. Inverse transform and quantization unit 308 may inverse quantize and/or inverse transform the quantized transform coefficients to determine a decoded prediction error. Combiner 310 may combine the decoded prediction error with a prediction block to form a decoded block. The prediction block may be generated by intra prediction unit 318 or inter prediction unit 316 (e.g., as described above with respect to encoder 200 in FIG. 2). Filter(s) 312 may filter the decoded block, for example, using a deblocking filter and/or a sample-adaptive offset (SAO) filter. Buffer 314 may store the decoded block for prediction of one or more other blocks in the same and/or different picture of the video sequence in bitstream 302. Decoded video sequence 304 may be output from filter(s) 312 as shown in FIG. 3.

Decoder 300 is merely an example and decoders different from decoder 300 and/or modified versions of decoder 300 may perform the methods and processes as described herein. For example, decoder 300 may have other components and/or arrangements. One or more of the components shown in FIG. 3 may be optionally included in decoder 300 (e.g., entropy decoding unit 306 and/or filters(s) 312).

Although not shown in FIGS. 2 and 3, each of encoder 200 and decoder 300 may further comprise an intra block copy unit in addition to inter prediction and intra prediction units. The intra block copy unit may perform/operate similar to an inter prediction unit but may predict blocks within the same picture. For example, the intra block copy unit may exploit repeated patterns that appear in screen content. The screen content may include computer generated text, graphics, animation, etc.

Video encoding and/or decoding may be performed on a block-by-block basis. The process of partitioning a picture into blocks may be adaptive based on the content of the picture. For example, larger block partitions may be used in areas of a picture with higher levels of homogeneity to improve coding efficiency.

A picture (e.g., in HEVC, or any other coding standard/format) may be partitioned into non-overlapping square blocks, which may be referred to as coding tree blocks (CTBs). The CTBs may comprise samples of a sample array. A CTB may have a size of 2n×2n samples, where n may be specified by a parameter of the encoding system. For example, n may be 4, 5, 6, or any other value. A CTB may have any other size. A CTB may be further partitioned by a recursive quadtree partitioning into coding blocks (CBs) of half vertical and half horizontal size. The CTB may form the root of the quadtree. A CB that is not split further as part of the recursive quadtree partitioning may be referred to as a leaf CB of the quadtree, and otherwise may be referred to as a non-leaf CB of the quadtree. A CB may have a minimum size specified by a parameter of the encoding system. For example, a CB may have a minimum size of 4×4, 8×8, 16×16, 32×32, 64×64 samples, or any other minimum size. A CB may be further partitioned into one or more prediction blocks (PBs) for performing inter and/or intra prediction. A PB may be a rectangular block of samples on which the same prediction type/mode may be applied. For transformations, a CB may be partitioned into one or more transform blocks (TBs). A TB may be a rectangular block of samples that may determine/indicate an applied transform size.

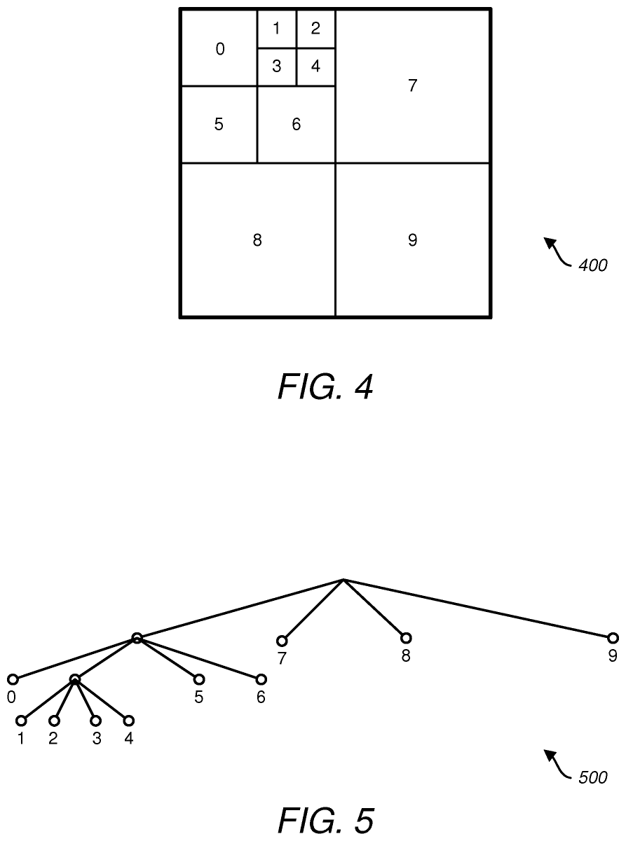

FIG. 4 shows an example quadtree partitioning of a CTB 400. FIG. 5 shows an example quadtree 500 corresponding to the example quadtree partitioning of CTB 400 in FIG. 4. As shown in the examples of FIGS. 4 and 5, CTB 400 may first be partitioned into four CBs of half vertical and half horizontal size. Three of the resulting CBs of the first level partitioning of CTB 400 are leaf CBs. The three leaf CBs of the first level partitioning of CTB 400 are respectively labeled 7, 8, and 9 in FIGS. 4 and 5. The non-leaf CB of the first level partitioning of CTB 400 is partitioned into four sub-CBs of half vertical and half horizontal size. Three of the resulting sub-CBs of the second level partitioning of CTB 400 are leaf CBs. The three leaf CBs of the second level partitioning of CTB 400 are respectively labeled 0, 5, and 6 in FIGS. 4 and 5. Finally, the non-leaf CB of the second level partitioning of CTB 400 is partitioned into four leaf CBs of half vertical and half horizontal size. The four leaf CBs are respectively labeled 1, 2, 3, and 4 in FIGS. 4 and 5.

The example CTB 400 of FIG. 4 is partitioned into 10 leaf CBs respectively labeled 0-9, but may be partitioned into other quantities of leaf CBs. The 10 leaf CBs may correspond to 10 CB leaf nodes (e.g., 10 CB leaf nodes of quadtree 500 as shown in FIG. 5). In other examples, a CTB may be partitioned into a different number of leaf CBs. The resulting quadtree partitioning of CTB 400 may be scanned using a z-scan (e.g., left-to-right, top-to-bottom) to form the sequence order for encoding/decoding the CB leaf nodes. A numeric label (e.g., indicator, index) of each CB leaf node in FIGS. 4 and 5 may correspond to the sequence order for encoding/decoding. For example, CB leaf node 0 may be encoded/decoded first and CB leaf node 9 may be encoded/decoded last. Although not shown in FIGS. 4 and 5, each CB leaf node may comprise one or more PBs and/or TBs.

A picture, in VVC (or in any other coding standard/format), may be partitioned in a similar manner (such as in HEVC). A picture may be first partitioned into non-overlapping square CTBs. The CTBs may then be partitioned, using a recursive quadtree partitioning, into CBs of half vertical and half horizontal size. A quadtree leaf node (e.g., in VVC) may be further partitioned by a binary tree or ternary tree partitioning (or any other partitioning) into CBs of unequal sizes.

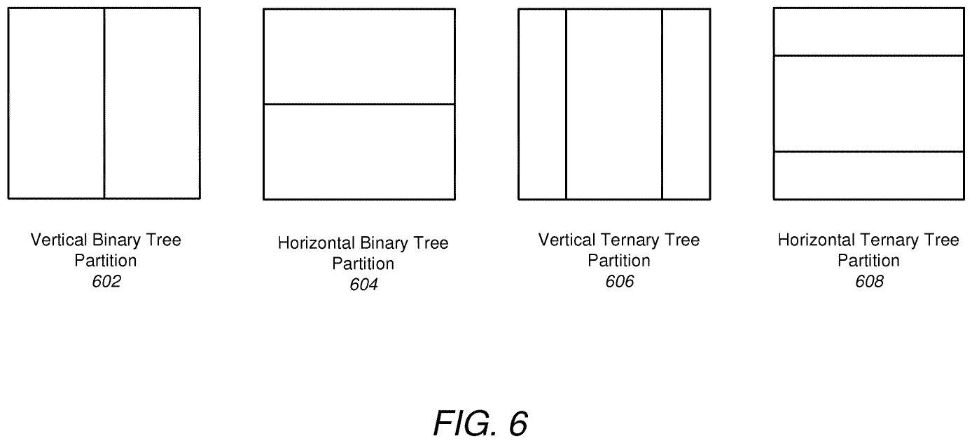

FIG. 6 shows example binary tree and ternary tree partitions. A binary tree partition may divide a parent block in half in either a vertical direction 602 or a horizontal direction 604. The resulting partitions may be half in size as compared to the parent block. In other examples, the resulting partitions may correspond to sizes that are less than and/or greater than half of the parent block size. A ternary tree partition may divide a parent block into three parts in either a vertical direction 606 or a horizontal direction 608. FIG. 6 shows an example in which the middle partition may be twice as large as the other two end partitions in the ternary tree partitions. In other examples, partitions may be of other sizes relative to each other and to the parent block. Binary and ternary tree partitions are examples of multi-type tree partitioning. Multi-type tree partitions may comprise partitioning a parent block into other quantities of smaller blocks. The block partitioning strategy (e.g., in VVC) may be referred to as a combination of quadtree and multi-type tree partitioning (quadtree+multi-type tree partitioning) because of the addition of binary and/or ternary tree partitioning to quadtree partitioning.

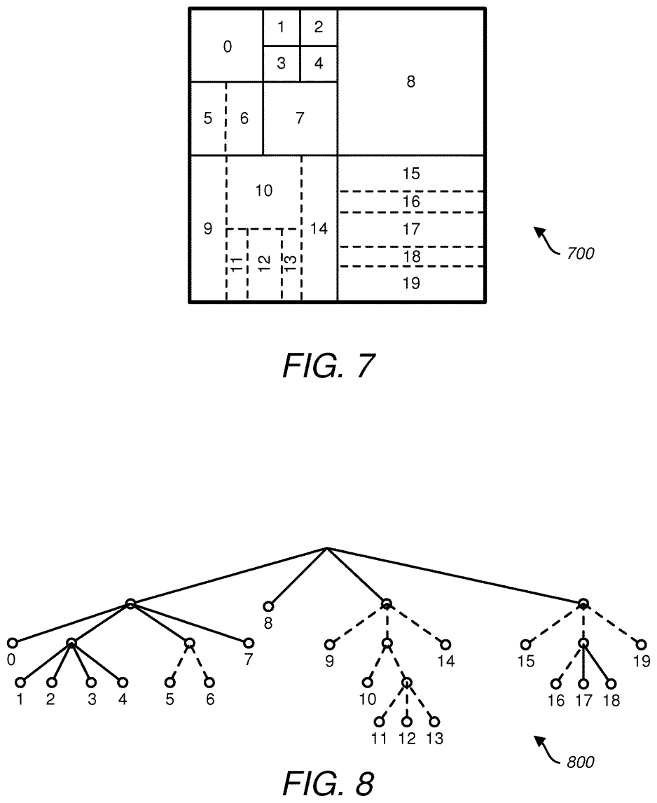

FIG. 7 shows an example of combined quadtree and multi-type tree partitioning of a CTB 700. FIG. 8 shows an example tree 800 corresponding to the combined quadtree and multi-type tree partitioning of CTB 700 shown in FIG. 7. In both FIGS. 7 and 8, quadtree splits are shown in solid lines and multi-type tree splits are shown in dashed lines. For ease of explanation, CTB 700 is shown with the same quadtree partitioning as the CTB 400 described in FIG. 4, and a description of the quadtree partitioning of CTB 700, which is similar to that for CTB 400, is omitted. The quadtree partitioning of the CTB 700 is merely an example and a CTB may be quadtree partitioned in a manner different from the CTB 700. Additional multi-type tree partitions of CTB 700 may be made relative to three leaf CBs shown in FIG. 4. The three leaf CBs in FIG. 4 that are shown in FIG. 7 as being further partitioned may be leaf CBs 5, 8, and 9. The three leaf CBs may be further partitioned using one or more binary and/or ternary tree partitions.

The leaf CB 5 of FIG. 4 may be partitioned into two CBs based on a vertical binary tree partitioning. The two resulting CBs may be leaf CBs respectively labeled 5 and 6 in FIGS. 7 and 8. The leaf CB 8 of FIG. 4 may be partitioned into three CBs based on a vertical ternary tree partition. Two of the three resulting CBs may be leaf CBs respectively labeled 9 and 14 in FIGS. 7 and 8. The remaining, non-leaf CB may be partitioned first into two CBs based on a horizontal binary tree partition. One of the two CBs may be a leaf CB labeled 10. The other of the two CBs may be further partitioned into three CBs based on a vertical ternary tree partition. The resulting three CBs may be leaf CBs respectively labeled 11, 12, and 13 in FIGS. 7 and 8. The leaf CB 9 of FIG. 4 may be partitioned into three CBs based on a horizontal ternary tree partition. Two of the three CBs may be leaf CBs respectively labeled 15 and 19 in FIGS. 7 and 8. The remaining, non-leaf CB may be partitioned into three CBs based on another horizontal ternary tree partition. The resulting three CBs may all be leaf CBs respectively labeled 16, 17, and 18 in FIGS. 7 and 8.

Altogether, CTB 700 may be partitioned into 20 leaf CBs respectively labeled 0-19. The 20 leaf CBs may correspond to 20 leaf nodes (e.g., 20 leaf nodes of tree 800 shown in FIG. 8). The resulting combination of quadtree and multi-type tree partitioning of the CTB 700 may be scanned using a z-scan (left-to-right, top-to-bottom) to form the sequence order for encoding/decoding the CB leaf nodes. A numeric label of each CB leaf node in FIGS. 7 and 8 may correspond to the sequence order for encoding/decoding, with CB leaf node 0 encoded/decoded first and CB leaf node 19 encoded/decoded last. Although not shown in FIGS. 7 and 8, it should be noted that each CB leaf node may comprise one or more PBs and/or TBs.

A coding standard/format (e.g., HEVC, VVC, or any other coding standard/format) may define various units (e.g., in addition to specifying various blocks (e.g., CTBs, CBs, PBs, TBs)). Blocks may comprise a rectangular area of samples in a sample array. Units may comprise the collocated blocks of samples from the different sample arrays (e.g., luma and chroma sample arrays) that form a picture as well as syntax elements and prediction data of the blocks. A coding tree unit (CTU) may comprise the collocated CTBs of the different sample arrays and may form a complete entity in an encoded bitstream. A coding unit (CU) may comprise the collocated CBs of the different sample arrays and syntax structures used to code the samples of the CBs. A prediction unit (PU) may comprise the collocated PBs of the different sample arrays and syntax elements used to predict the PBs. A transform unit (TU) may comprise TBs of the different samples arrays and syntax elements used to transform the TBs.

A block may refer to any of a CTB, CB, PB, TB, CTU, CU, PU, and/or TU (e.g., in the context of HEVC, VVC, or any other coding format/standard). A block may be used to refer to similar data structures in the context of any video coding format/standard/protocol. For example, a block may refer to a macroblock in the AVC standard, a macroblock or a sub-block in the VP8 coding format, a superblock or a sub-block in the VP9 coding format, and/or a superblock or a sub-block in the AV1 coding format.

In intra prediction, samples of a block to be encoded (e.g., also referred to as a current block) may be predicted from samples of the column immediately adjacent to the left-most column of the current block and samples of the row immediately adjacent to the top-most row of the current block. The samples from the immediately adjacent column and row may be jointly referred to as reference samples. Each sample of the current block may be predicted (e.g., in an intra prediction mode) by projecting the position of the sample in the current block in a given direction to a point along the reference samples. The sample may be predicted by interpolating between the two closest reference samples of the projection point if the projection does not fall directly on a reference sample. A prediction error (e.g., referred to as a residual) may be determined for the current block based on differences between the predicted sample values and the original sample values of the current block.

Predicting samples and determining a prediction error based on a difference between the predicted samples and original samples may be performed (e.g., at an encoder) for a plurality of different intra prediction modes (e.g., including non-directional intra prediction modes). The encoder may select one of the plurality of intra prediction modes and its corresponding prediction error to encode the current block. The encoder may send an indication of the selected prediction mode and its corresponding prediction error to a decoder for decoding of the current block. The decoder may decode the current block by predicting the samples of the current block, using the intra prediction mode indicated by the encoder, and/or combining the predicted samples with the prediction error.

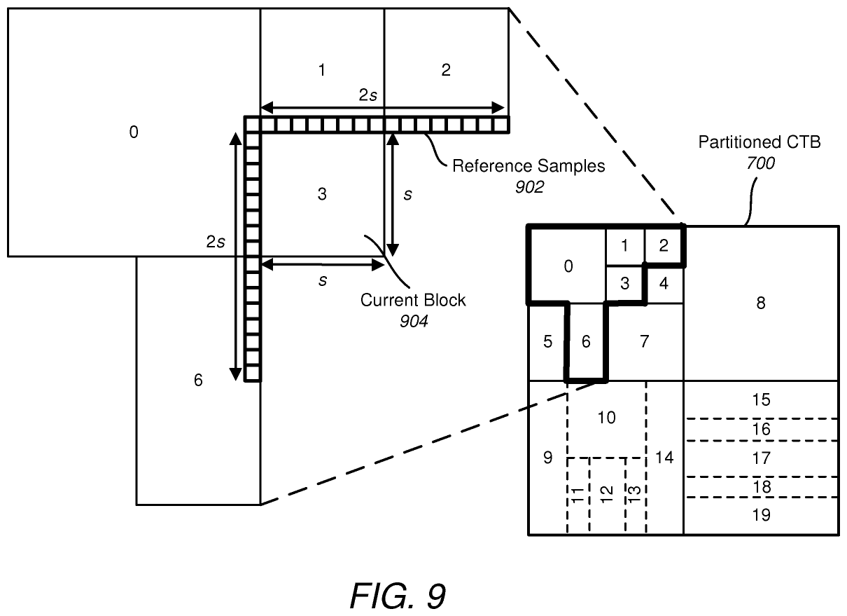

FIG. 9 shows an example set of reference samples 902 determined for intra prediction of a current block 904. Current block 904 may correspond to a block being encoded and/or decoded. Current block 904 may correspond to block 3 of partitioned CTB 700 as shown in FIG. 7. As described herein, the numeric labels 0-19 of the blocks of partitioned CTB 700 may correspond to the sequence order for encoding/decoding the blocks and may be used as such in the example of FIG. 9.

For current block 904 that is w×h samples in size, reference samples 902 may comprise: 2w samples (or any other quantity of samples) of the row immediately adjacent to the top-most row of current block 904, 2h samples (or any other quantity of samples) of the column immediately adjacent to the left-most column of current block 904, and the top left neighboring corner sample to current block 904. Current block 904 may be square, such that w=h=s. In other examples, a current block need not be square, such that w≠h. Available samples from neighboring blocks of current block 904 may be used for constructing the set of reference samples 902. Samples may not be available for constructing the set of reference samples 902, for example, if the samples lie outside the picture of the current block, the samples are part of a different slice of the current block (e.g., if the concept of slices is used), and/or the samples belong to blocks that have been inter coded and constrained intra prediction is indicated. Intra prediction may not be dependent on inter predicted blocks, for example, if constrained intra prediction is indicated.

Samples that may not be available for constructing the set of reference samples 902 may comprise samples in blocks that have not already been encoded and reconstructed at an encoder and/or decoded at a decoder based on the sequence order for encoding/decoding. Restriction of such samples from inclusion in the set of reference samples 902 may allow identical prediction results to be determined at both the encoder and decoder. In the example of FIG. 9, samples from neighboring blocks 0, 1, and 2 may be available to construct reference samples 902 given that these blocks are encoded and reconstructed at an encoder and decoded at a decoder prior to coding of current block 904. The samples from neighboring blocks 0, 1, and 2 may be available to construct reference samples 902, for example, if there are no other issues (e.g., as mentioned above) preventing the availability of the samples from the neighboring blocks 0, 1, and 2. The portion of reference samples 902 from neighboring block 6 may not be available due to the sequence order for encoding/decoding (e.g., because the block 6 may not have already been encoded and reconstructed at the encoder and/or decoded at the decoder based on the sequence order for encoding/decoding).

In some examples, unavailable samples from reference samples 902 may be filled with one or more of the available reference samples 902. For example, an unavailable reference sample may be filled with a nearest available reference sample. The nearest available reference sample may be determined by moving in a clock-wise direction through reference samples 902 from the position of the unavailable reference. The reference samples 902 may be filled with the mid-value of the dynamic range of the picture being coded, for example, if no reference samples are available.

Reference samples 902 may be filtered based on the size of current block 904 being coded and an applied intra prediction mode. FIG. 9 shows an example determination of reference samples for intra prediction of a block. Reference samples may be determined in a different manner than described above. For example, multiple reference lines may be used in other instances (e.g., in VVC).

Samples of current block 904 may be intra predicted based on reference samples 902, for example, based on (e.g., after) determination and (optionally) filtering of reference samples 902. At least some (e.g., most) encoders/decoders may support a plurality of intra prediction modes in accordance with one or more video coding standards. For example, HEVC supports 35 intra prediction modes, including a planar mode, a direct current (DC) mode, and 33 angular modes. VVC supports 67 intra prediction modes, including a planar mode, a DC mode, and 65 angular modes. Planar and DC modes may be used to predict smooth and gradually changing regions of a picture. Angular modes may be used to predict directional structures in regions of a picture. Any quantity of intra prediction modes may be supported.

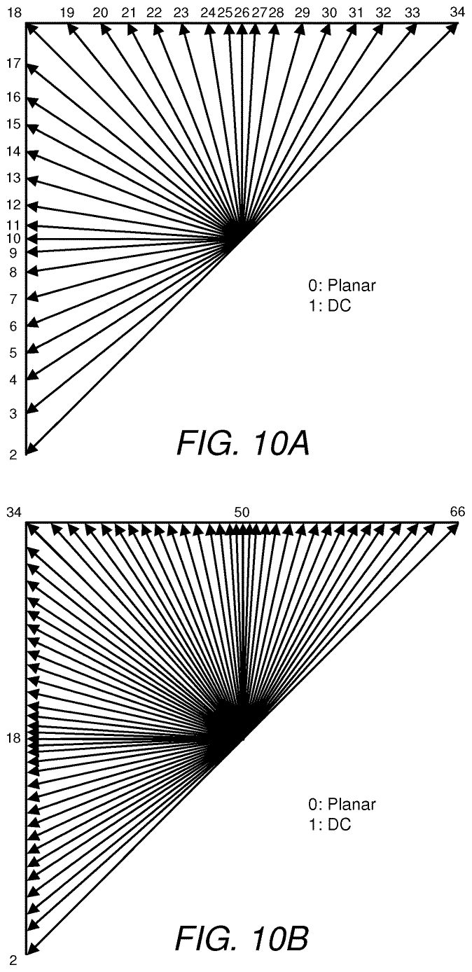

FIGS. 10A and 10B show example intra prediction modes. FIG. 10A shows 35 intra prediction modes, such as supported by HEVC. The 35 intra prediction modes may be indicated/identified by indices 0 to 34. Prediction mode 0 may correspond to planar mode. Prediction mode 1 may correspond to DC mode. Prediction modes 2-34 may correspond to angular modes. Prediction modes 2-18 may be referred to as horizontal prediction modes because the principal source of prediction is in the horizontal direction. Prediction modes 19-34 may be referred to as vertical prediction modes because the principal source of prediction is in the vertical direction.

FIG. 10B shows 67 intra prediction modes, such as supported by VVC. The 67 intra prediction modes may be indicated/identified by indices 0 to 66. Prediction mode 0 may correspond to planar mode. Prediction mode 1 corresponds to DC mode. Prediction modes 2-66 may correspond to angular modes. Prediction modes 2-34 may be referred to as horizontal prediction modes because the principal source of prediction is in the horizontal direction. Prediction modes 35-66 may be referred to as vertical prediction modes because the principal source of prediction is in the vertical direction. Some of the intra prediction modes illustrated in FIG. 10B may be adaptively replaced by wide-angle directions because blocks in VVC need not be squares.

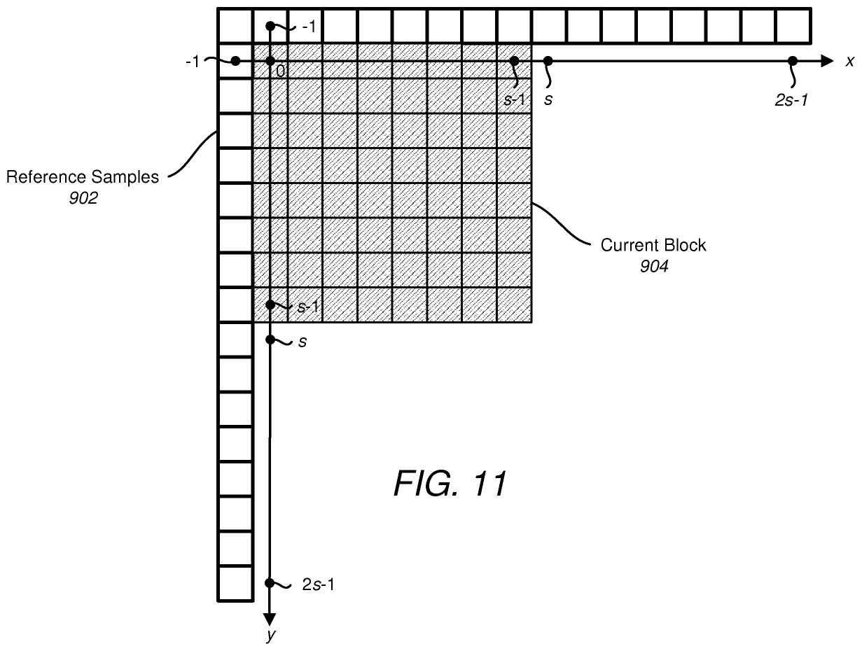

FIG. 11 shows a current block 904 and corresponding reference samples 902 from FIG. 9. To further describe how intra prediction modes are applied to determine a prediction (e.g., a prediction block) of current block 904, FIG. 11 shows current block 904 and reference samples 902 in a two-dimensional x, y plane, where a sample may be referenced as p[x][y]. To simplify the prediction process, reference samples 902 may be placed in two, one-dimensional arrays. The reference samples 902, above the current block 904, may be placed in the one-dimensional array ref₁[x]:

$${ref}_{1} [ x ] = p [ - 1 + x ] [ - 1 ] , ( x \geq 0 ) . \qquad ( 1 )$$

The reference samples 902 to the left of current block 904 may be placed in the one-dimensional array ref₂[y]:

$${ref}_{2} [ y ] = p [ - 1 ] [ - 1 + y ] , ( y \geq 0 ) . \qquad ( 2 )$$

The prediction process may comprise determination of a predicted sample p[x][y] (e.g., a predicted value) at a location [x][y] in current block 904. For planar mode, a sample at the location [x][y] in current block 904 may be predicted by determining/calculating the mean of two interpolated values. The first of the two interpolated values may be based on a horizontal linear interpolation at the location [x][y] in current block 904. The second of the two interpolated values may be based on a vertical linear interpolation at location [x][y] in current block 904. The predicted sample p[x][y] in current block 904 may be determined/calculated as:

$$p [ x ] [ y ] = \frac{1}{2 \cdot s} ( h [ x ] [ y ] + v [ x ] [ y ] + s ) , \qquad ( 3 )$$

$$where$$

$$h [ x ] [ y ] = ( s - x - 1 ) \cdot {ref}_{2} [ y ] + ( x + 1 ) \cdot {ref}_{1} [ s ] \qquad ( 4 )$$

may be the horizonal linear interpolation at the location [x][y] in current block 904 and

$$v [ x ] [ y ] = ( s - y - 1 ) \cdot {ref}_{1} [ x ] + ( y + 1 ) \cdot {ref}_{2} [ s ] \qquad ( 5 )$$

may be the vertical linear interpolation at the location [x][y] in current block 904. s may be equal to a length of a side (e.g., a number of samples on a side) of the current block 904.

For DC mode, a sample at a location [x][y] in current block 904 may be predicted by the mean of the reference samples 902. The predicted sample p[x][y] in current block 904 may be determined/calculated as:

$$p [ x ] [ y ] = \frac{1}{2 \cdot s} ( {\sum }_{x = 0}^{s - 1} {ref}_{1} [ x ] + {\sum }_{y = 0}^{s - 1} {ref}_{2} [ y ] ) . \qquad ( 6 )$$

For angular modes, a sample at a location [x][y] in current block 904 may be predicted by projecting the location [x][y] in a direction specified by a given angular mode to a point on the horizontal or vertical line of samples comprising reference samples 902. The sample at the location [x][y] may be predicted by interpolating between the two closest reference samples of the projection point if the projection does not fall directly on a reference sample. The direction specified by the angular mode may be given by an angle q defined relative to the y-axis for vertical prediction modes (e.g., modes 19-34 in HEVC and modes 35-66 in VVC). The direction specified by the angular mode may be given by an angle q defined relative to the x-axis for horizontal prediction modes (e.g., modes 2-18 in HEVC and modes 2-34 in VVC).

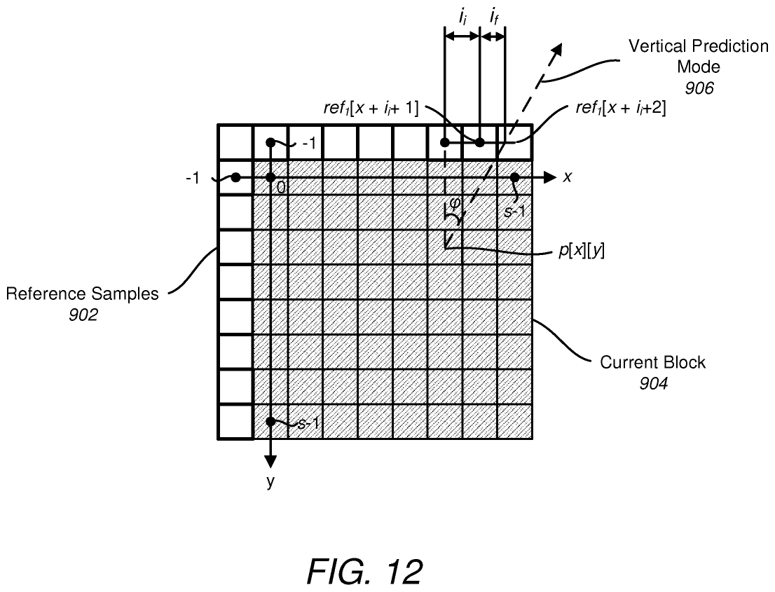

FIG. 12 shows an example applying an intra prediction mode (e.g., an angular mode such as vertical prediction mode 906) for prediction of a current block 904. FIG. 12 specifically shows prediction of a sample at a location [x][y] in current block 904 for a vertical prediction mode 906. Vertical prediction mode 906 may be given by an angle q with respect to the vertical axis. The location [x][y] in current block 904, in vertical prediction modes, may be projected to a point (e.g., referred to as a projection point) on the horizontal line of reference samples ref₁[x]. The reference samples 902 are only partially shown in FIG. 12 for ease of illustration. As shown in FIG. 12, the projection point on the horizontal line of reference samples ref₁[x] may not be exactly on a reference sample. A predicted sample p[x][y] in current block 904 may be determined/calculated by linearly interpolating between the two reference samples, for example, if the projection point falls at a fractional sample position between two reference samples. The predicted sample p[x][y] may be determined/calculated as:

$$p [ x ] [ y ] = ( 1 - {i}_{f} ) \cdot {ref}_{1} [ x + {i}_{i} + 1 ] + {i}_{f} \cdot {ref}_{1} [ x + {i}_{i} + 2 ] . \qquad ( 7 )$$

iᵢ may be the integer part of the horizontal displacement of the projection point relative to the location [x][y]. iᵢ may be determined/calculated as a function of the tangent of the angle q of the vertical prediction mode 906 as:

$${i}_{i} = ⌊ ( y + 1 ) \cdot tan φ ⌋ . \qquad ( 8 )$$

i_{f} may be the fractional part of the horizontal displacement of the projection point relative to the location [x][y] and may be determined/calculated as:

$${i}_{f} = ( ( y + 1 ) \cdot tan φ ) - ⌊ ( y + 1 ) \cdot tan φ ⌋ , \qquad ( 9 )$$

where └⋅┘ is the integer floor function.

For horizontal prediction modes, a location [x][y] of a sample in current block 904 may be projected onto the vertical line of reference samples ref₂[y]. A predicted sample p[x][y] for horizontal prediction modes may be determined/calculated as:

$$p [ x ] [ y ] = ( 1 - {i}_{f} ) \cdot {ref}_{2} [ y + {i}_{i} + 1 ] + {i}_{f} \cdot {ref}_{2} [ y + {i}_{i} + 2 ] . \qquad ( 10 )$$

iᵢ may be the integer part of the vertical displacement of the projection point relative to the location [x][y]. iᵢ may be determined/calculated as a function of the tangent of the angle q of the horizontal prediction mode as:

$${i}_{i} = ⌊ ( x + 1 ) \cdot tan φ ⌋ . \qquad ( 11 )$$

i_{f} may be the fractional part of the vertical displacement of the projection point relative to the location [x][y]. i_{f} may be determined/calculated as:

$${i}_{f} = ( ( x + 1 ) \cdot tan φ ) - ⌊ ( x + 1 ) \cdot tan φ ⌋ , \qquad ( 12 )$$

where └⋅┘ is the integer floor function.

The interpolation functions given by Equations (7) and (10) may be implemented by an encoder and/or a decoder (e.g., encoder 200 in FIG. 2 and/or decoder 300 in FIG. 3). The interpolation functions may be implemented by finite impulse response (FIR) filters. For example, the interpolation functions may be implemented as a set of two-tap FIR filters. The coefficients of the two-tap FIR filters may be respectively given by (1−i_{f}) and i_{f}. The predicted sample p[x][y], in angular intra prediction, may be calculated with some predefined level of sample accuracy (e.g., 1/32 sample accuracy, or accuracy defined by any other metric). For 1/32 sample accuracy, the set of two-tap FIR interpolation filters may comprise up to 32 different two-tap FIR interpolation filters-one for each of the 32 possible values of the fractional part of the projected displacement if. In other examples, different levels of sample accuracy may be used.

In some examples, the FIR filters may be used for predicting chroma samples and/or luma samples. For example, the two-tap interpolation FIR filter may be used for predicting chroma samples and a same and/or a different interpolation technique/filter may be used for luma samples. For example, a four-tap FIR filter may be used to determine a predicted value of a luma sample. Coefficients of the four tap FIR filter may be determined based on if (e.g., similar to the two-tap FIR filter). For 1/32 sample accuracy, a set of 32 different four-tap FIR filters may comprise up to 32 different four-tap FIR filters-one for each of the 32 possible values of the fractional part of the projected displacement if. In other examples, different levels of sample accuracy may be used. The set of four-tap FIR filters may be stored in a look-up table (LUT) and referenced based on if. A predicted sample p[x][y], for vertical prediction modes, may be determined based on the four-tap FIR filter as:

$$p [ x ] ⌈ y ] = {\sum }_{i = 0}^{3} f T [ i ] \cdot {ref}_{1} [ x + iIdx + i ] , \qquad ( 13 )$$

where fT[i], i=0 . . . 3, may be the filter coefficients, and Idx is integer displacement. A predicted sample p[x][y], for horizontal prediction modes, may be determined based on the four-tap FIR filter as:

$$p [ x ] [ y ] = {\sum }_{i = 0}^{3} f T [ i ] \cdot {ref}_{2} [ y + iIdx + i ] . \qquad ( 14 )$$

Supplementary reference samples may be determined/constructed if the location [x][y] of a sample in current block 904 to be predicted is projected to a negative x coordinate. The location [x][y] of a sample may be projected to a negative x coordinate, for example, if negative vertical prediction angles q are used. The supplementary reference samples may be determined/constructed by projecting the reference samples in ref₂[y] in the vertical line of reference samples 902 to the horizontal line of reference samples 902 using the negative vertical prediction angle φ. Supplementary reference samples may be similarly determined/constructed, for example, if the location [x][y] of a sample in current block 904 to be predicted is projected to a negative y coordinate. The location [x][y] of a sample may be projected to a negative y coordinate, for example, if negative horizontal prediction angles φ are used. The supplementary reference samples may be determined/constructed by projecting the reference samples in ref₁[x] on the horizontal line of reference samples 902 to the vertical line of reference samples 902 using the negative horizontal prediction angle q.

An encoder may determine/predict samples of a current block being encoded (e.g., current block 904) for a plurality of intra prediction modes (e.g., using one or more of the functions described herein). For example, an encoder may determine/predict samples of a current block for each of 35 intra prediction modes in HEVC and/or 67 intra prediction modes in VVC. The encoder may determine, for each intra prediction mode applied, a corresponding prediction error for the current block based on a difference (e.g., sum of squared differences (SSD), sum of absolute differences (SAD), or sum of absolute transformed differences (SATD)) between the prediction samples determined for the intra prediction mode and the original samples of the current block. The encoder may determine/select one of the intra prediction modes to encode the current block based on the determined prediction errors. For example, the encoder may determine/select one of the intra prediction modes that results in the smallest prediction error for the current block. In some examples, the encoder may determine/select the intra prediction mode to encode the current block based on a rate-distortion measure (e.g., Lagrangian rate-distortion cost) determined using the prediction errors. The encoder may send an indication of the determined/selected intra prediction mode and its corresponding prediction error (e.g., residual) to a decoder for decoding of the current block.

A decoder may determine/predict samples of a current block being decoded (e.g., current block 904) for an intra prediction mode. For example, a decoder may receive an indication of an intra prediction mode (e.g., an angular intra prediction mode) from an encoder for a current block. The decoder may construct a set of reference samples and perform intra prediction based on the intra prediction mode indicated by the encoder for the current block in a similar manner (e.g., as described above for the encoder). The decoder may add predicted values of the samples (e.g., determined based on the intra prediction mode) of the current block to a residual of the current block to reconstruct the current block. In some examples, a decoder need not receive an indication of an angular intra prediction mode from an encoder for a current block. Instead, the decoder may determine an intra prediction mode through other, decoder-side means.

While various examples herein correspond to intra prediction modes in HEVC and VVC, the methods, devices, and systems as described herein may be applied to/used for other intra prediction modes (e.g., as used in other video coding standards/formats, such as VP8, VP9, AV1, etc.).

Intra prediction may exploit correlations between spatially neighboring samples in the same picture of a video sequence to perform video compression. Inter prediction is another coding tool that may be used to perform video compression. Inter prediction may exploit correlations in the time domain between blocks of samples in different pictures of a video sequence. For example, an object may be seen across multiple pictures of a video sequence. The object may move (e.g., by some translation and/or affine motion) or remain stationary across the multiple pictures. A current block of samples in a current picture being encoded may have/be associated with a corresponding block of samples in a previously decoded picture. The corresponding block of samples may accurately predict the current block of samples. The corresponding block of samples may be displaced from the current block of samples, for example, due to movement of the object, represented in both blocks, across the respective pictures of the blocks. The previously decoded picture may be a reference picture. The corresponding block of samples in the reference picture may be a reference block for motion compensated prediction. An encoder may use a block matching technique to estimate the displacement (or motion) of the object and/or to determine the reference block in the reference picture.

Similar to intra prediction, an encoder may determine a difference between a current block and a prediction for a current block. An encoder may determine a difference, for example, based on/after determining/generating a prediction for a current block (e.g., using inter prediction). The difference may be a prediction error (e.g., a residual). The encoder may store and/or send (e.g., signal), in/via a bitstream, the prediction error and/or other related prediction information. The prediction error and/or other related prediction information may be used for decoding and/or other forms of consumption. A decoder may decode the current block by predicting the samples of the current block (e.g., by using the related prediction information) and combining the predicted samples with the prediction error.

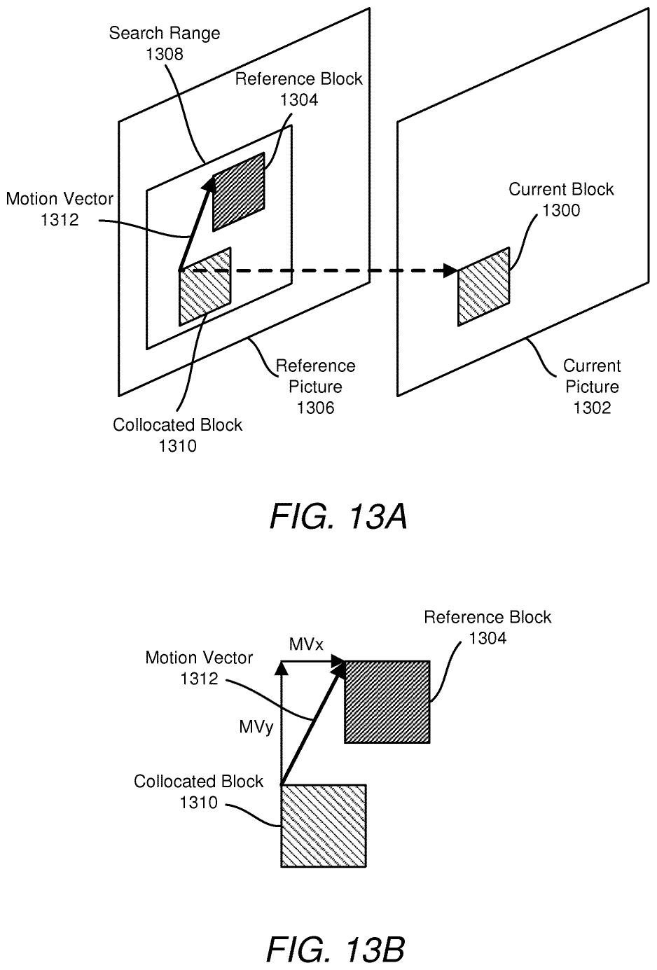

FIG. 13A shows an example of inter prediction. The inter prediction may be performed for a current block 1300 in a current picture 1302 being encoded. An encoder (e.g., encoder 200 as shown in FIG. 2) may perform inter prediction to determine and/or generate a reference block 1304 in a reference picture 1306. Reference block 1304 may be used to predict the current block 1300. Reference pictures (e.g., reference picture 1306) may be prior decoded pictures available at the encoder and/or a decoder. Availability of a prior decoded picture may depend/be based on whether the prior decoded picture is available in a decoded picture buffer, at the time, current block 1300 is being encoded and/or decoded. The encoder may search the one or more reference pictures 1306 for a block (e.g., a candidate reference block) that is similar (or substantially similar) to current block 1300. The encoder may determine the best matching block from the blocks (e.g., candidate reference blocks) tested during the searching process. The best matching block may be a reference block 1304. The encoder may determine that reference block 1304 is the best matching reference block based on one or more cost criteria. The one or more cost criteria may comprise a rate-distortion criterion (e.g., Lagrangian rate-distortion cost). The one or more cost criteria may be based on a difference (e.g., SSD, SAD, and/or SATD) between prediction samples of reference block 1304 and original samples of current block 1300.

The encoder may search for reference block 1304 within a reference region (e.g., a search range 1308). The reference region (e.g., a search range 1308) may be positioned around a collocated block (or position) 1310, of current block 1300, in reference picture 1306. Collocated block 1310 may have a same position in the reference picture 1306 as the current block 1300 in the current picture 1302. The reference region (e.g., search range 1308) may at least partially extend outside of reference picture 1306. Constant boundary extension may be used, for example, if the reference region (e.g., search range 1308) extends outside of reference picture 1306. The constant boundary extension may be used such that values of the samples in a row or a column of reference picture 1306, immediately adjacent to a portion of the reference region (e.g., search range 1308) extending outside of reference picture 1306, may be used for sample locations outside of reference picture 1306. A subset of potential positions, or all potential positions, within the reference region (e.g., search range 1308) may be searched for reference block 1304. The encoder may utilize one or more search implementations to determine and/or generate the reference block 1304. For example, the encoder may determine a set of candidate search positions based on motion information of neighboring blocks (e.g., a motion vector 1312) to the current block 1300.

One or more reference pictures may be searched by the encoder during inter prediction to determine and/or generate the best matching reference block. The reference pictures searched by the encoder may be included in (e.g., added to) one or more reference picture lists. For example, in HEVC and VVC (and/or in one or more other communication protocols), two reference picture lists may be used (e.g., a reference picture list 0 and a reference picture list 1). A reference picture list may include one or more pictures. The reference picture 1306 of reference block 1304 may be indicated by a reference index pointing into a reference picture list comprising reference picture 1306.

FIG. 13B shows an example motion vector. A displacement between reference block 1304 and current block 1300 may be interpreted as an estimate of the motion between reference block 1304 and current block 1300 across their respective pictures. The displacement may be represented by a motion vector 1312. For example, motion vector 1312 may be indicated by a horizontal component (MVx) and a vertical component (MVy) relative to the position of current block 1300. A motion vector (e.g., motion vector 1312) may have fractional or integer resolution. A motion vector with fractional resolution may point between two samples in a reference picture to provide a better estimation of the motion of current block 1300. For example, a motion vector may have ½, ¼, ⅛, 1/16, 1/32, or any other fractional sample resolution. Interpolation between the two samples at integer positions may be used to generate a reference block and its corresponding samples at fractional positions, for example, if a motion vector points to a non-integer sample value in the reference picture. The interpolation may be performed by a filter with two or more taps.

The encoder may determine a difference (e.g., a corresponding sample-by-sample difference) between reference block 1304 and current block 1300. The encoder may determine the difference between reference block 1304 and current block 1300, for example, based on/after reference block 1304 is determined and/or generated, using inter prediction, for current block 1300. The difference may be a prediction error (e.g., a residual). The encoder may store and/or send (e.g., signal), in/via a bitstream, the prediction error and/or related motion information. The prediction error and/or the related motion information may be used for decoding (e.g., decoding current block 1300) and/or other forms of consumption. The motion information may comprise the motion vector 1312 and a reference indicator/index. The reference indicator may indicate the reference picture 1306 in a reference picture list. In other examples, the motion information may comprise an indication of motion vector 1312 and/or an indication of the reference indicator/index. The reference indicator may indicate reference picture 1306 in the reference picture list comprising reference picture 1306. A decoder may decode current block 1300 by determining and/or generating the reference block 1304, which may correspond to/form (e.g., be considered as) a prediction of the current block 1300. The decoder may determine and/or generate the reference block 1304, for example, based on the related motion information. The decoder may decode current block 1300 based on combining the prediction (e.g., a reference block) with the prediction error (e.g., a residual block).

Inter prediction, as shown in FIG. 13A, may be performed using one reference picture 1306 as a source of a prediction for current block 1300. Inter prediction based on a prediction of a current block using a single picture may be referred to as uni-prediction.

Inter prediction of a current block, using bi-prediction, may be based on two pictures (e.g., the source of prediction may be from the two pictures). Bi-prediction may be useful, for example, if a video sequence comprises fast motion, camera panning, zooming, and/or scene changes. Bi-prediction also may be useful to capture fade outs of one scene or fade outs from one scene to another, where two pictures may effectively be displayed simultaneously with different levels of intensity.

One or both of uni-prediction and bi-prediction may be available/used for performing inter prediction (e.g., at an encoder and/or at a decoder). Performing a specific type of inter prediction (e.g., uni-prediction and/or bi-prediction) may depend on a slice type of current block. For example, for P slices, only uni-prediction may be available/used for performing inter prediction. For B slices, either uni-prediction or bi-prediction may be available/used for performing inter prediction. An encoder may determine and/or generate a reference block, for predicting a current block, from a reference picture list 0, for example, if the encoder is using uni-prediction. An encoder may determine and/or generate a first reference block, for predicting a current block, from a reference picture list 0 and determine and/or generate a second reference block, for predicting the current block, from a reference picture list 1, for example, if the encoder is using bi-prediction.

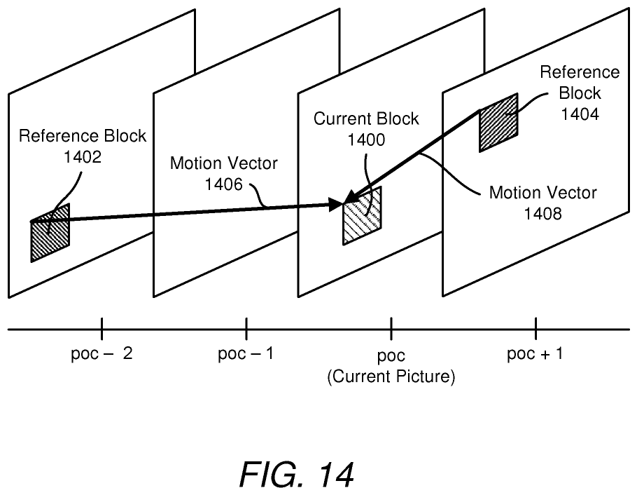

FIG. 14 shows an example of bi-prediction. Two reference blocks 1402 and 1404 may be used to predict a current block 1400. Reference block 1402 may be in a reference picture of one of reference picture list 0 or reference picture list 1. Reference block 1404 may be in a reference picture of another one of reference picture list 0 or reference picture list 1. As shown in FIG. 14, reference block 1402 may be in a first picture that precedes (e.g., in time) a current picture of current block 1400, and the reference block 1404 may be in a second picture that succeeds (e.g., in time) the current picture of current block 1400. The first picture may precede the current picture in terms of a picture order count (POC). The second picture may succeed the current picture in terms of the POC. In other examples, the reference pictures may both precede or both succeed the current picture in terms of POC. A POC may be/indicate an order in which pictures are output (e.g., from a decoded picture buffer). A POC may be/indicate an order in which pictures are generally intended to be displayed. Pictures that are output may not necessarily be displayed but may undergo different processing and/or consumption (e.g., transcoding). The two reference blocks determined and/or generated using/for bi-prediction may correspond to (e.g., be comprised in) a same reference picture. The reference picture may be included in both the reference picture list 0 and the reference picture list 1, for example, if the two reference blocks correspond to the same reference picture.

A configurable weight and/or offset value may be applied to one or more inter prediction reference blocks. An encoder may enable the use of weighted prediction using a flag in a picture parameter set (PPS). The encoder may send/signal the weight and/or offset parameters in a slice segment header for current block 1400. Different weight and/or offset parameters may be sent/signaled for luma and/or chroma components.

The encoder may determine and/or generate the reference blocks 1402 and 1404 for the current block 1400 using inter prediction. The encoder may determine a difference between current block 1400 and each of reference blocks 1402 and 1404. The differences may be prediction errors or residuals. The encoder may store and/or send/signal, in/via a bitstream, the prediction errors and/or their respective related motion information. The prediction errors and their respective related motion information may be used for decoding and/or other forms of consumption.

The motion information for reference block 1402 may comprise a motion vector 1406 and/or a reference indicator/index. The reference indicator may indicate a reference picture, of the reference block 1402, in a reference picture list. In some examples, the motion information for reference block 1402 may comprise an indication of motion vector 1406 and/or an indication of the reference index. The reference index may indicate the reference picture, of reference block 1402, in the reference picture list.

The motion information for reference block 1404 may comprise a motion vector 1408 and/or a reference index/indicator. The reference indicator may indicate a reference picture, of the reference block 1404, in a reference picture list. The motion information for reference block 1404 may comprise an indication of motion vector 1408 and/or an indication of the reference index. The reference index may indicate the reference picture, of the reference block 1404, in the reference picture list.

A decoder may decode current block 1400 by determining and/or generating the reference blocks 1402 and 1404. The decoder may determine and/or generate the reference blocks 1402 and 1404, for example, based on the respective related motion information for the reference blocks 1402 and 1404. The reference blocks 1402 and 1404 may correspond to/form (e.g., be considered as) the prediction (e.g., used to generate a prediction block) of the current block 1400. The decoder may decode the current block 1400 based on combining the prediction with the prediction errors.

Motion information may be predictively coded, for example, before being stored and/or sent/signaled in/via a bit stream (e.g., in HEVC, VVC, and/or other video coding standards/formats/protocols). The motion information for a current block may be predictively coded based on motion information of one or more blocks neighboring the current block. The motion information of the neighboring block(s) may often correlate with the motion information of the current block because the motion of an object represented in the current block is often the same as (or similar to) the motion of objects in the neighboring block(s). Motion information prediction techniques (such as those in HEVC and VVC) may comprise advanced motion vector prediction (AMVP) and/or inter prediction block merging (e.g., merge mode).

An encoder (e.g., encoder 200 as shown in FIG. 2), may code a motion vector. The encoder may code the motion vector (e.g., using AMVP) as a difference between a motion vector of a current block being coded and a motion vector predictor (MVP). An encoder may determine/select the MVP from a list of candidate MVPs. The candidate MVPs may be/correspond to previously decoded motion vectors of neighboring blocks in the current picture of the current block, and/or blocks at or near the collocated position of the current block in other reference pictures. The encoder and/or a decoder may reciprocally generate and/or determine the list of candidate MVPs.

The encoder may determine/select an MVP from the list of candidate MVPs. Then, the encoder may send/signal, in/via a bitstream, an indication of the selected MVP and/or a motion vector difference (MVD). The encoder may indicate the selected MVP in the bitstream using an index/indicator. The index may indicate the selected MVP in the list of candidate MVPs. The MVD may be determined/calculated based on a difference between the motion vector of the current block and the selected MVP. For example, for a motion vector (e.g., comprising a horizontal component (MVx) and a vertical component (MVy) that indicates a position relative to a position of the current block being coded, the MVD may be represented by two components MVDₓ and MVD_{y}. MVDₓ and MVD_{y} may be determined/calculated as:

$${MVD}_{x} = {MV}_{x} - {MVP}_{x} , \qquad ( 15 )$$

$${MVD}_{y} = {MV}_{y} - {MVP}_{y} . \qquad ( 16 )$$

MVDx and MVDy may respectively represent horizontal and vertical components of the MVD. MVPx and MVPy may respectively represent horizontal and vertical components of the MVP.

A decoder (e.g., decoder 300 as shown in FIG. 3) may decode the motion vector by adding the MVD to the MVP indicated in/via the bitstream. The decoder may decode the current block by determining and/or generating the reference block. The decoder may determine and/or generate the reference block, for example, based on the decoded motion vector. The reference block may correspond to/form (e.g., be considered as) the prediction of the current block (e.g., a prediction block). The decoder may decode the current block by combining the prediction with the prediction error.

The list of candidate MVPs (e.g., in HEVC, VVC, and/or one or more other communication protocols), for AMVP, may comprise two or more candidates (e.g., candidates A and B). Candidates A and B may comprise: up to two (or any other quantity of) spatial candidate MVPs determined/derived from five (or any other quantity of) spatial neighboring blocks of a current block being coded; one (or any other quantity of) temporal candidate MVP determined/derived from two (or any other quantity of) temporal, co-located blocks (e.g., if both of the two spatial candidate MVPs are not available or are identical); and/or zero motion vector candidate MVPs (e.g., if one or both of the spatial candidate MVPs or temporal candidate MVPs are not available). Other quantities of spatial candidate MVPs, spatial neighboring blocks, temporal candidate MVPs, and/or temporal, co-located blocks may be used for the list of candidate MVPs.

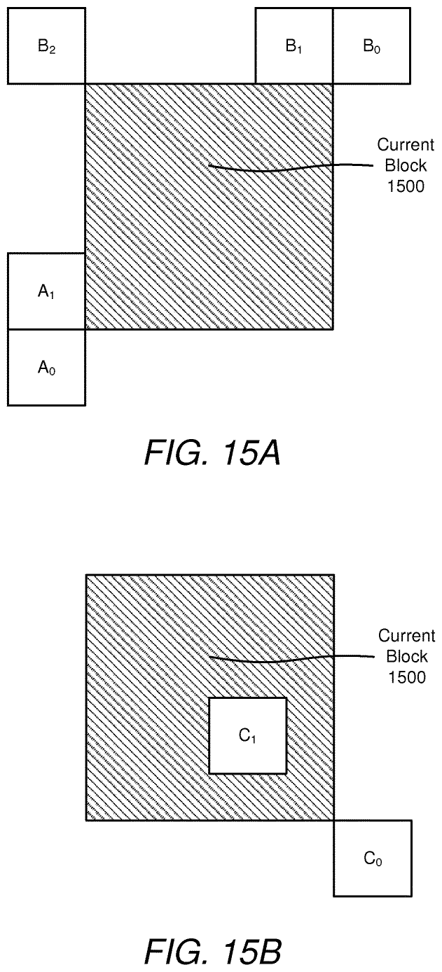

FIG. 15A shows example spatial candidate neighboring blocks for a current block. For example, five (or any other quantity of) spatial candidate neighboring blocks may be located relative to a current block 1500 being encoded. The five spatial candidate neighboring blocks may be A0, A1, B0, B1, and B2. FIG. 15B shows temporal, co-located blocks for the current block. For example, two (or any other quantity of) temporal, co-located blocks may be located relative to current block 1500 being coded. The two temporal, co-located blocks may be C0 and C1. The two temporal, co-located blocks may be in one or more reference pictures that may be different from the current picture of current block 1500.

An encoder (e.g., encoder 200 as shown in FIG. 2) may code a motion vector using inter prediction block merging (e.g., a merge mode). For example, the encoder (e.g., using merge mode) may reuse the same motion information of a neighboring block (e.g., one of neighboring blocks A0, A1, B0, B1, and B2) for inter prediction of a current block. For example, the encoder (e.g., using merge mode) may reuse the same motion information of a temporal, co-located block (e.g., one of temporal, co-located blocks C0 and C1) for inter prediction of a current block. An MVD need not be sent (e.g., indicated, signaled) for the current block because the same motion information as that of a neighboring block or a temporal, co-located block may be used for the current block (e.g., at the encoder and/or a decoder). A signaling overhead for sending/signaling the motion information of the current block may be reduced because the MVD need not be indicated for the current block. The encoder and/or the decoder may reciprocally generate a candidate list of motion information from neighboring blocks or temporal, co-located blocks of the current block (e.g., in a manner similar to AMVP). The encoder may determine to use (e.g., inherit) motion information, of one neighboring block or one temporal, co-located block in the candidate list, for predicting motion information of the current block being coded. The encoder may signal/send, in/via a bitstream, an indication of the determined motion information from the candidate list. For example, the encoder may signal/send an indicator/index. The index may indicate the determined motion information in the list of candidate motion information. The encoder may signal/send the index to indicate the determined motion information.

A list of candidate motion information for merge mode (e.g., in HEVC, VVC, or any other coding formats/standards/protocols) may comprise: up to four (or any other quantity of) spatial merge candidates derived/determined from five (or any other quantity of) spatial neighboring blocks (e.g., as shown in FIG. 15A); one (or any other quantity of) temporal merge candidate derived from two (or any other quantity of) temporal, co-located blocks (e.g., as shown in FIG. 15B); and/or additional merge candidates comprising bi-predictive candidates and zero motion vector candidates. In some examples, the spatial neighboring blocks and the temporal, co-located blocks used for merge mode may be the same as the spatial neighboring blocks and the temporal, co-located blocks used for AMVP.

Inter prediction may be performed in other ways and variants than those described herein. For example, motion information prediction techniques other than AMVP and merge mode may be used. While various examples herein correspond to inter prediction modes, such as used in HEVC and VVC, the methods, devices, and systems as described herein may be applied to/used for other inter prediction modes (e.g., as used for other video coding standards/formats such as VP8, VP9, AV1, etc.). History based motion vector prediction (HMVP), combined intra/inter prediction mode (CIIP), and/or merge mode with motion vector difference (MMVD) (e.g., as described in VVC) may be performed/used and are within the scope of the present disclosure.

A block matching operation (or technique) may be applied/used (e.g., in inter prediction) to determine a reference block in a different picture than that of a current block being coded (e.g., encoded and/or decoded). A block matching operation also may be applied/used to determine a reference block in a same picture as that of a current block being coded. The reference block, in a same picture as that of the current block, as determined using block matching may often not accurately predict the current block (e.g., for camera captured videos). Prediction accuracy for screen content videos may not be similarly impacted, for example, if a reference block in the same picture as that of the current block is used for encoding. Screen content videos may comprise, for example, computer generated text, graphics, animation, etc. Screen content videos may comprise (e.g., may often comprise) repeated patterns (e.g., repeated patterns of text and/or graphics) within the same picture. Using a reference block (e.g., as determined using block matching), in a same picture as that of a current block being encoded, may provide efficient compression for screen content videos.

A prediction technique may be used (e.g., in HEVC, VVC, and/or any other coding standards/formats/protocols) to exploit correlation between blocks of samples within a same picture (e.g., of screen content videos). The prediction technique may be intra block copy (IBC) or current picture referencing (CPR). An encoder may apply/use a block matching technique (e.g., similar to inter prediction) to determine a displacement vector (e.g., a block vector (BV). The BV may indicate a relative position of a reference block (e.g., in accordance with intra block compensated prediction), that best matches the current block, from a position of the current block. For example, the relative position of the reference block may be a relative position of a top-left corner (or any other point/sample) of the reference block. The BV may indicate a relative displacement from the current block to the reference block that best matches the current block. The encoder may determine the best matching reference block from blocks tested during a searching process (e.g., in a manner similar to that used for inter prediction). The encoder may determine that a reference block is the best matching reference block based on one or more cost criteria. The one or more cost criteria may comprise a rate-distortion criterion (e.g., Lagrangian rate-distortion cost). The one or more cost criteria may be based on, for example, one or more differences (e.g., an SSD, an SAD, an SATD, and/or a difference determined based on a hash function) between the prediction samples of the reference block and the original samples of the current block. A reference block may correspond to/comprise prior decoded blocks of samples (e.g., reconstructed samples) of the current picture. The reference block may comprise decoded blocks of samples of the current picture prior to being processed by in-loop filtering operations (e.g., deblocking and/or SAO filtering).

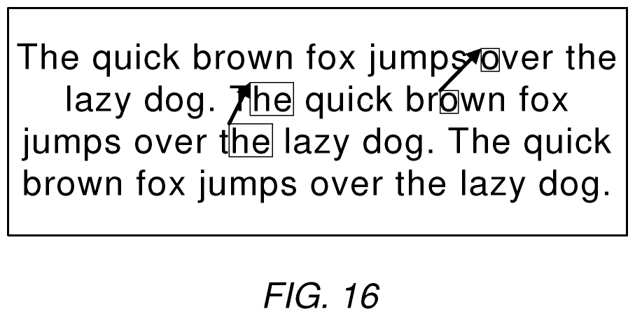

FIG. 16 shows an example of IBC (e.g., an IBC mode). The example shown in FIG. 16 may correspond to screen content. The rectangular portions/sections with arrows beginning at their boundaries may be the current blocks being encoded. The rectangular portions/sections that the arrows point to may be the reference blocks for predicting the respective current blocks.

A reference block may be determined and/or generated, for a current block, using IBC. The encoder may determine a difference (e.g., a corresponding sample-by-sample difference) between the reference block and the current block. The difference may be a prediction error or residual. The encoder may store and/or send/signal, in/via a bitstream the prediction error and/or related prediction information. The prediction error and/or the related prediction information may be used for decoding and/or other forms of consumption. The prediction information may comprise a BV. The prediction information may comprise an indication of the BV. A decoder (e.g., decoder 300 as shown in FIG. 3), may decode the current block by determining and/or generating the reference block. The decoder may determine and/or generate the current block, for example, based on the prediction information (e.g., the BV). The reference block may correspond to/form (e.g., be considered as) the prediction (e.g., a prediction block) of the current block. The decoder may decode the current block by combining the prediction (e.g., prediction block) with the prediction error (e.g., residual or residual block).

A BV may be predictively coded (e.g., in HEVC, VVC, and/or any other coding standards/formats/protocols) before being stored and/or sent/signaled in/via a bitstream. For example, the BV for a current block may be predictively coded based on a BV of one or more blocks neighboring the current block. For example, an encoder may predictively code a BV using the merge mode (e.g., in a manner similar to as described herein for inter prediction), AMVP (e.g., as described herein for inter prediction), or a technique similar to AMVP. The technique similar to AMVP may be BV prediction and difference coding (or AMVP for IBC).

An encoder (e.g., encoder 200 as shown in FIG. 2) performing BV prediction and coding may code a BV as a difference between the BV of a current block being coded and a block vector predictor (BVP). An encoder may select/determine the BVP from a list of candidate BVPs. The candidate BVPs may comprise/correspond to previously decoded BVs of neighboring blocks in the current picture of the current block. The encoder and/or a decoder may reciprocally generate or determine the list of candidate BVPs.

The encoder may send/signal, in/via a bitstream, an indication of the selected BVP and a block vector difference (BVD). The encoder may indicate the selected BVP in the bitstream using an index/indicator. The index may indicate (e.g., point to) the selected BVP in the list of candidate BVPs. The BVD may be determined/calculated based on a difference between a BV of the current block and the selected BVP. For example, for a BV (e.g., represented by a horizontal component (BVx) and a vertical component (BVy)) that indicates a position relative to a position of the current block being coded, the BVD may be represented by two components BVD, and BVDy. BVD, and BVDy may be determined/calculated as:

$${BVD}_{x} = {BV}_{x} - {BVP}_{x} , \qquad ( 17 )$$

$${BVD}_{y} = {BV}_{y} - {BVP}_{y} . \qquad ( 18 )$$

BVDx and BVDy may respectively represent horizontal and vertical components of the BVD. BVPx and BVPy may respectively represent horizontal and vertical components of the BVP. A decoder (e.g., decoder 300 as shown in FIG. 3), may decode the BV by adding the BVD to the BVP indicated in/via the bitstream. The decoder may decode the current block by determining and/or generating the reference block. The decoder may determine and/or generate the reference block, for example, based on the decoded BV. The reference block may correspond to/form (e.g., be considered as) the prediction (e.g., a prediction block) of the current block. The decoder may decode the current block by combining the prediction (e.g., the prediction block) with the prediction error (e.g., residual or residual block).

A same BV as that of a neighboring block may be used for the current block and a BVD need not be separately signaled/sent for the current block, such as in the merge mode. A BVP (in the candidate BVPs), which may correspond to a decoded BV of the neighboring block, may itself be used as a BV for the current block. Not sending the BVD may reduce the signaling overhead.

A list of candidate BVPs (e.g., in HEVC, VVC, and/or any other coding standard/format/protocol) may comprise two (or more) candidates. The candidates may comprise candidates A and B. Candidates A and B may comprise: up to two (or any other quantity of) spatial candidate BVPs determined/derived from five (or any other quantity of) spatial neighboring blocks of a current block being encoded; and/or one or more of last two (or any other quantity of) coded BVs (e.g., if spatial neighboring candidates are not available). Spatial neighboring candidates may not be available, for example, if neighboring blocks are encoded using intra prediction or inter prediction. Locations of the spatial candidate neighboring blocks, relative to a current block, being encoded using IBC may be illustrated in a manner similar to spatial candidate neighboring blocks used for coding motion vectors in inter prediction (e.g., as shown in FIG. 15A). For example, five spatial candidate neighboring blocks of a current block being coded using IBC may be respectively denoted A0, A1, B0, B1, and B2 as shown in FIG. 15A.

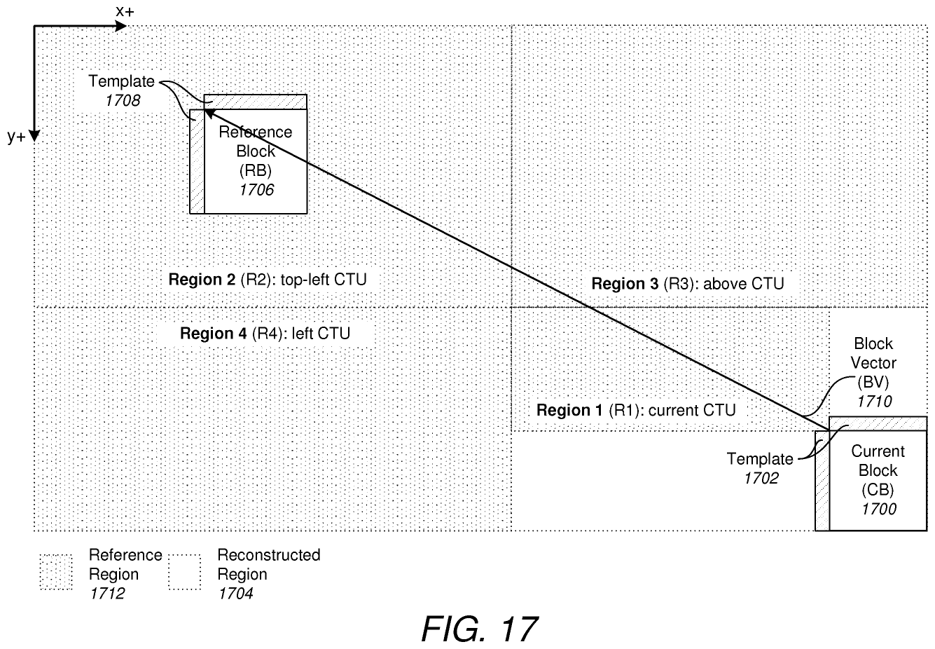

FIG. 17 illustrates an example of template matching prediction (TMP) for predicting a current block (CB), according to some embodiments. Template matching prediction (TMP) is a prediction method that may be implemented by an encoder and decoder. In TMP, a reconstructed region may be searched for a template of a reference block (RB) that matches a template of a current block (CB). The template of the RB indicates a location of the RB in the reconstructed region, and the RB at this location may be used to predict the CB.

FIG. 17 further illustrates an example of TMP for predicting a current block (CB) 1700. CB 1700 comprises a rectangular block of samples to be encoded by an encoder. To perform TMP for predicting CB 1700, the encoder may determine or construct a template 1702 of CB 1700. The encoder may determine or construct template 1702 based on samples in a reconstructed region 1704. In an example, template 1702 may comprise samples in reconstructed region 1704 that are adjacent to the samples of CB 1700. For example, template 1702 may comprise samples in reconstructed region 1704 to the left and/or above CB 1700.

After determining or constructing template 1702 of CB 1700, the encoder may search reconstructed region 1704 for a template of a reference block (RB) (e.g., RB 1706) that is determined to match template 1702 of CB 1700. The encoder may search reconstructed region 1704 for a template of an RB that matches template 1702 of CB 1700 by determining a cost between template 1702 and one or more templates of one or more reference blocks (RBs) in reconstructed region 1704. In an example, the cost may be based on a difference (e.g., sum of squared differences (SSD), sum of absolute differences (SAD), sum of absolute transformed differences (SATD), or difference determined based on a hash function) between a template of an RB and template 1702 of CB 1700. In the example illustrated by FIG. 17, template 1708 of RB 1706 is determined to match template 1702 of CB 1700 (e.g., based on the cost between template 1702 of CB 1700 and template 1708 of RB 1706). A block vector (BV) (e.g., BV 1710) may indicate the displacement of an RB (e.g., RB 1706) relative to a CB (e.g., CB 1700).

After determining that template 1708 of RB 1706 matches template 1702 of CB 1700, the encoder may use RB 1706 to predict CB 1700. For example, the encoder may determine a difference (e.g., a corresponding sample-by-sample difference) between CB 1700 and RB 1706. The difference may be referred to as a prediction error or residual. The encoder may store and/or signal in a bitstream the prediction error or residual for decoding by a decoder.

To perform TMP for predicting CB 1700, a decoder may perform the same operations as the encoder as described above with respect to FIG. 17. For example, based on receiving an indication from the encoder that TMP is used to predict CB 1700 (e.g., via a syntax element or flag), the decoder may similarly determine or construct template 1702 of CB 1700. After determining or constructing template 1702, the decoder may further similarly search reconstructed region 1704 for a template of an RB that is determined to match template 1702 of CB 1700. For example, the decoder may determine that template 1708 of RB 1706 matches template 1702 of CB 1700. After determining that template 1708 of RB 1706 matches template 1702 of CB 1700, the decoder may use RB 1706 to predict CB 1700. The decoder may combine the residual received from the encoder with RB 1706 to reconstruct CB 1700.

FIG. 17 also illustrates an example reference region 1712. Reference region 1712 comprises a portion of reconstructed region 1704. Reference region 1712 indicates the regions that the encoder or decoder may search for one or more matching templates of RBs for template 1702 of CB 1700. Reference region 1712 may include four regions (e.g., four search regions R1-R4 as shown in FIG. 17). In some embodiments, the reference region 1712 includes three regions or fewer regions (e.g., three search regions). In some embodiments, the reference region 1712 includes five regions or more regions (e.g., six search regions). Relative to CB 1700, region 1 (R1) is the current CTU, region 2 (R2) is the top-left CTU, region 3 (R3) is the above CTU, and region 4 (R4) is the left CTU. The CTUs are a result of picture partitioning operations described in more detail above. For example, an encoder or decoder may search for a matching template within reference region 1712, i.e., within each of R1, R2, R3, and R4. For example, template 1708 of RB 1706 may be determined to match template 1702 of CB 1700 based on a SAD cost or some other cost as described above. The decoder may use RB 1706 to predict CB 1700 as described above. In some embodiments, an encoder or decoder searches for a matching template in R1, R2, R3, and R4 in serial in any suitable order. In some embodiments, an encoder or decoder searches for a matching template in R1, R2, R3, and R4 in parallel to reduce search time for matching template.

Further, in practice, the dimensions of reference region 1712 (referred to as SearchRange_w, SearchRange_h) may be set proportionally to the dimensions of CB 1700 (referred to as BlkW, BlkH), for example, in order to have a fixed number of SAD comparisons (or other difference comparisons) per pixel. More specifically, the dimensions of reference region 1712 may be calculated as follows:

$$SearchRange\_w = a * BlkW \qquad ( 19 )$$

$$SearchRange\_h = a * BlkH \qquad ( 20 )$$

where ‘a’ (or alpha) is a constant that controls a gain/complexity trade-off for the encoder or decoder. In practice, ‘a’ may be equal to 5. In FIG. 17, it should further be noted that the dimensions of the regions of reference region 1712, as well as reconstructed region 1704, are illustrated by example and not by limitation. In practice, for example, the dimensions of the regions may vary, and one or more of the regions may not be present. In the example illustrated by FIG. 17, portions of reconstructed region 1704 directly above and directly left of CB 1700 may not be available for prediction and are thus excluded from reference region 1712. For example, this may be because an RB in these portions would overlap with CB 1700, which would be an invalid location for prediction of CB 1700. A similar restriction may also be based on the unavailability of samples because of the sequence order of encoding or decoding, or because the samples may be outside of the reference region or the current picture.

In HEVC and VVC, intra block copy (IBC) is a type of predictive coding that may be implemented by an encoder and decoder. For example, an encoder, such as encoder 200 in FIG. 2, may use an IBC prediction mode to code a current block in a current picture (or portion of a current picture). A current block may also be referred to as a coding block within a coding tree unit (CTU). Unlike inter prediction that searches for a reference block in a prior decoded picture that is different than the picture of the current block being encoded, IBC searches for a reference block in the same, current picture as the current block. As a result, only part of the current picture may be available for searching for a reference block in IBC, for example, only the part of the current picture that has been decoded prior to the encoding of the current block. This may ensure the encoding and decoding systems can produce identical results but also limits the IBC reference region.

In an example, intra block copy (IBC) prediction information, e.g., a block vector predictor (BVP) and a block vector difference (BVD), may be signaled in a bitstream by an encoder and extracted from a bitstream by a decoder in order to decode a block vector (BV) for reconstructing a current block. For example, the encoder may signal, in a bitstream, the prediction error, an indication of a selected BVP (e.g., via an index pointing into a list of candidate BVPs, such as an AMVP list), the separate horizontal and vertical components of a BVD, as well as a sign of each of the separate horizontal and vertical components of the BVD. The decoder may decode the BV by adding the corresponding horizontal and vertical components of the BVD to the corresponding components horizontal and vertical components of the BVP. The decoder may decode a current block by determining a reference block, which forms the prediction of the current block, using the decoded BV and combining the prediction with the prediction error received in the bitstream.

In HEVC, VVC, and other video compression standards, blocks may be scanned from left-to-right, top-to-bottom using a z-scan to form the sequence order for encoding/decoding. Based on the z-scan, the CTUs to the left and in the row immediately above a current CTU may be encoded/decoded prior to a current CTU and a current block. Therefore, the samples of these CTUs may form an exemplary IBC reference region for determining a reference block to predict a current block. In other video encoders and decoders, a different sequence order for encoding/decoding may be used, which may influence an IBC reference region accordingly.

In addition to the encoding/decoding sequence order, one or more additional reference region constraints may be placed based on an IBC reference region. For example, an IBC reference region may be constrained to CTUs based on a parallel processing approach, like tiles or wavefront parallel processing (WPP). Tiles may be used as part of a picture partitioning process for flexibly subdividing a picture into rectangular regions of CTUs such that coding dependencies between CTUs of different tiles are not allowed. WPP may be similarly used as part of a picture partitioning process for partitioning a picture into CTU rows such that dependencies between CTUs of different partitions are not allowed. Each of these tools may enable parallel processing of the picture partitions. The top row of CTUs may not be part of the IBC reference region due to one of these parallel processing approaches.

For example, in addition to being constrained to a reconstructed part of a current picture and potentially to a particular wavefront parallel processing (WPP) partition or tile partition as mentioned above, an IBC reference region may be further constrained to include a number of decoded or reconstructed samples that may be stored in a limited size IBC reference sample memory. The size of the IBC reference sample memory may be limited based on being implemented on-chip with the encoder or decoder. The IBC reference region may be increased in size by using a larger size IBC reference sample memory off-chip from the encoder or decoder; however, such an approach may have its own drawbacks, such as increased off-chip memory bandwidth requirements and increased delay in writing and reading samples in the IBC reference region to and from the IBC reference sample memory.

In an embodiment, with a limited size IBC reference sample memory, the IBC reference region may be constrained to: a reconstructed part of the current CTU; and one or more reconstructed CTUs to the left of the current CTU not including a portion, of a left most one of the one or more reconstructed CTUs, collocated with either the reconstructed part of the current CTU or a virtual pipeline data unit (VPDU) in which the current block being coded is located. Blocks of samples in different CTUs may be collocated based on having a same size and CTU offset. A CTU offset of a block may be the offset of the block's top-left corner relative to the top-left corner of the CTU in which the block is located.

The IBC reference region may not include the portion, of the left most one of the more reconstructed CTUs, that is collocated with the reconstructed part of the current CTU because the IBC reference sample memory may be implemented similarly to a circular buffer. For example, the IBC reference sample memory may store reconstructed reference samples corresponding to one or more CTUs. Once the IBC reference sample memory is filled, reconstructed reference samples of the current CTU may replace the reconstructed reference samples of a CTU stored in the IBC reference sample memory that are located, within a picture or frame, farthest to the left of the current CTU. The samples of the CTU stored in the IBC reference sample memory that are located, within a picture or frame, farthest to the left of the current CTU may correspond to the oldest data in the IBC reference sample memory. This update mechanism allows some of the reconstructed reference samples from the left most CTU to remain stored in the IBC reference sample memory when processing the current CTU. The remaining reference samples of the left most CTU stored in the IBC reference sample memory may then be used for predicting the current block in the current CTU.

In addition, in typical hardware implementations of an encoder or decoder, a CTU may not be processed all at once. Instead, the CTU may be divided into VPDUs for processing by a pipeline stage. A VPDU may comprise a 4×4 region of samples, a 16×16 region of samples, a 32×32 region of samples, a 64×64 region of samples, a 128×128 region of samples, or some other sample region size. In an embodiment, a size of a VPDU may be determined based on a minimum of a maximum VPDU size (e.g., a 64×64 region of samples) and a size (e.g., a width or height) of a current CTU. The portion of the left most one of the one or more reconstructed CTUs that is collocated with the VPDU in which the block being coded is located may be further excluded from the IBC reference region as mentioned above. By excluding this region of the left most one of the one or more reconstructed CTUs from the IBC reference region, the corresponding portion of the IBC reference sample memory used to store reconstructed reference samples from this region may be used to store only samples within the region of the current CTU corresponding to the VPDU, which may avoid certain complexities in design.

The number of reconstructed CTUs to the left of the current CTU included in the IBC reference region may be determined based on the number of reconstructed reference samples the IBC reference sample memory may store and the size of the CTUs in the current picture. For example, the number of reconstructed CTUs to the left of the current CTU included in the IBC reference region may be determined based on the number of reconstructed reference samples the IBC reference sample memory may store divided by the size of a CTU in the current picture. Thus, for an IBC reference sample memory that may store 128×128 reconstructed reference samples for the IBC reference region and a CTU size of 128×128 samples, the number of reconstructed CTUs to the left of the current CTU included in the IBC reference region may be equal to (128×128)/(128×128) or 1 CTU. In another example, for a memory that may store 128×128 reconstructed reference samples for the IBC reference region and a CTU size of 64×64 samples, the number of reconstructed CTUs to the left of the current CTU included in the IBC reference region may be equal to (128×128)/(64×64) or 4 CTUs.

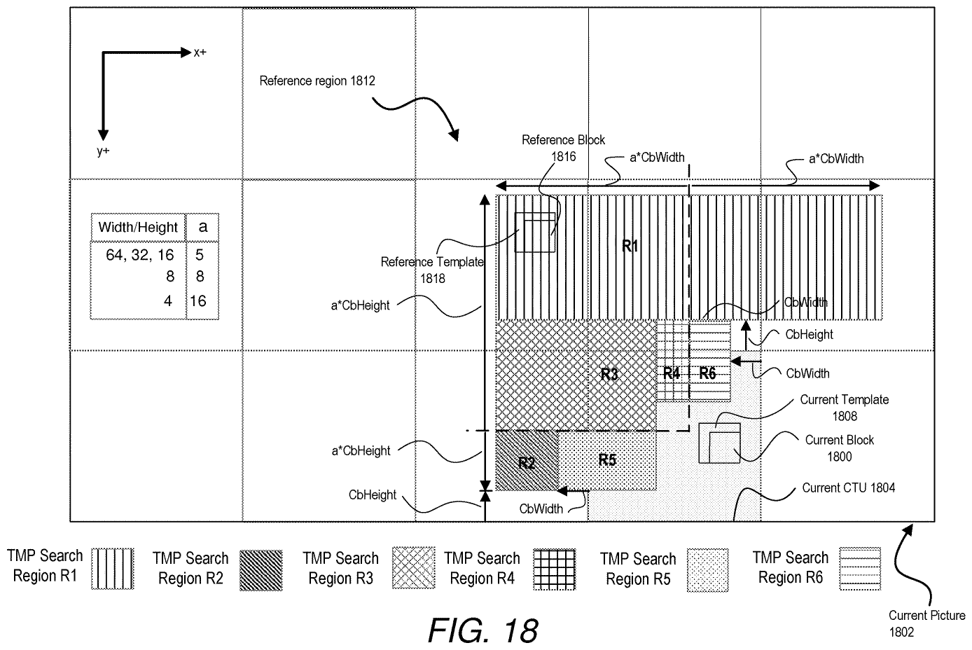

FIG. 18 illustrates an example of template matching prediction (TMP) for predicting a current block (CB) 1800, according to some embodiments. FIG. 18 further illustrates an example reference region 1812 including a plurality of template matching prediction (TMP) search regions (also referred to as “search regions” in this disclosure). As shown, the example reference region 1812 includes 6 TMP search regions (first TMP search region (R1), second TMP search region (R2), third TMP search region (R3), fourth TMP search region (R4), fifth TMP search region (R5), and sixth TMP search region (R6) in this example). The techniques that will be disclosed in the present disclosure may be implemented by a coder for searching for a matching reference template within reference region 1812 that includes 6 TMP search regions. The techniques also may be implemented for searching for the matching reference template within reference region 1812 that includes more than 6 TMP search regions. The techniques disclosed in the present disclosure may also be implanted for searching for the matching reference template within reference region 1812 that includes less than 6 TMP search regions.

In some embodiments, the coder may search for the matching reference template (e.g., reference template 1818) within reference region 1812. For example, the coder determines the matching reference template within each of the TMP search regions (first TMP search region R1, second TMP search region R2, third TMP search region (R3), fourth TMP search region (R4), fifth TMP search region (R5), and sixth TMP search region (R6) in this example).

As shown, the coder may determine a reference template (e.g., reference template 1818) of reference block (e.g., reference block 1816) matching with current template 1808 of current block 1800 based on a SAD cost or some other cost as described above. The coder may use reference block (e.g., reference block 1816) corresponding to the matching reference template (e.g., reference template 1818) to predict the current block 1800 associated with current template 1808 as described above.

In some embodiments, the coder searches for a matching reference template (e.g., reference template 1818) in the plurality of TMP search regions (first TMP search region (R1), second TMP search region (R2), third TMP search region (R3), fourth TMP search region (R4), fifth TMP search region (R5), and sixth TMP search region (R6) in this example) in serial in any suitable order. In some embodiments, the coder searches for a matching reference template (e.g., reference template 1818) in the plurality of TMP search regions (first TMP search region (R1), second TMP search region (R2), third TMP search region (R3), fourth TMP search region (R4), fifth TMP search region (R5), and sixth TMP search region (R6) in this example) in parallel to reduce search time for matching template.

As shown in FIG. 18, the size (e.g., dimension) of each TMP search region may be different. As shown, in some embodiments, the size (e.g., dimension) of each TMP search region may be different based on the size (e.g., dimension) of current block 1800. As shown, in some embodiments, the size of first TMP search region (R1) is greatest within reference region 1812. As a result, the coder may determine (e.g., compute, calculate) a greater number of costs based on current template 1808 and reference templates at different positions within first TMP search region (R1) than the number of costs based on the current template 1808 and reference templates at different positions within other search regions (e.g., second TMP search region (R2), third TMP search region (R3), fourth TMP search region (R4), fifth TMP search region (R5), sixth TMP search region (R6)).

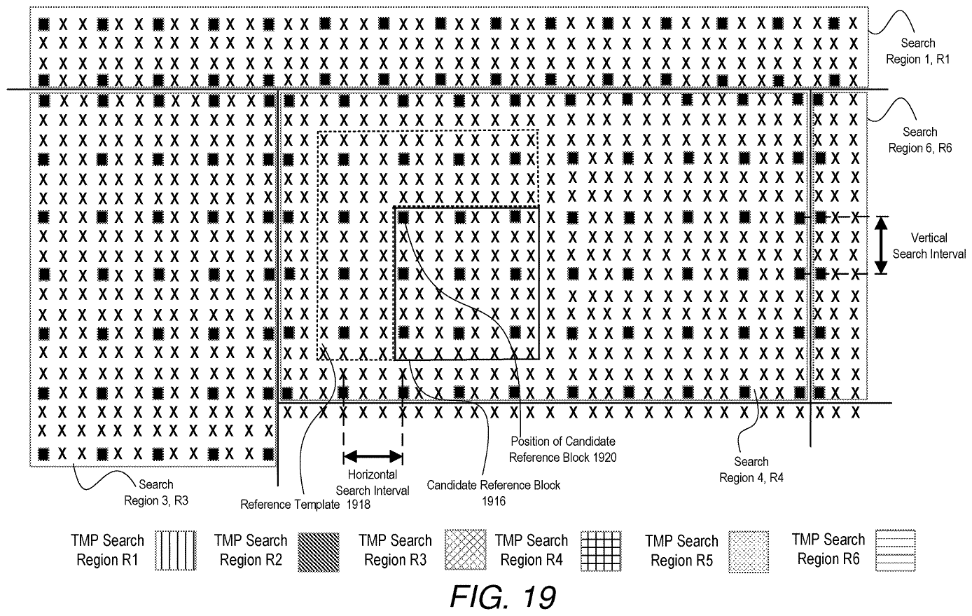

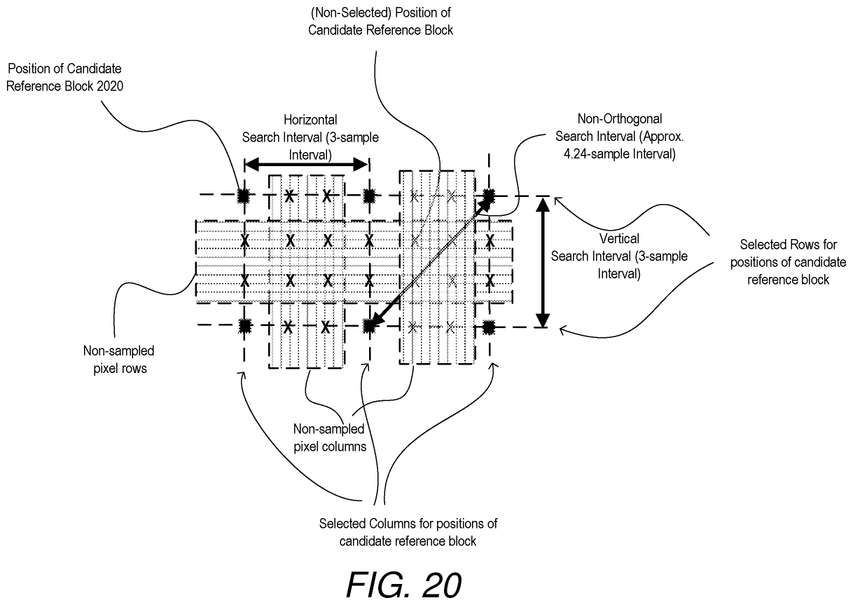

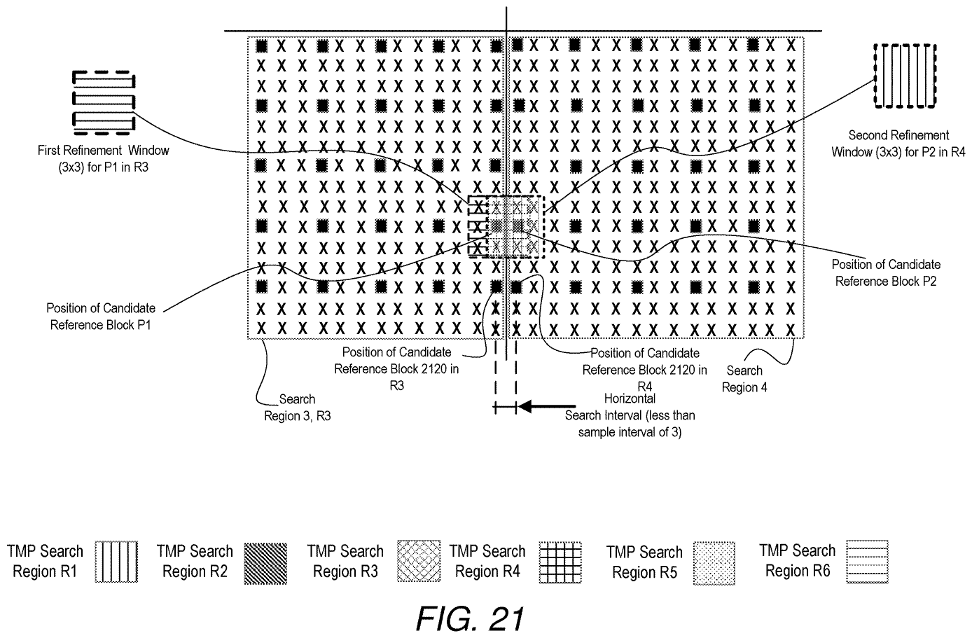

FIG. 19 illustrates an existing sampling interval (e.g., subsampling interval) method for searching for a matching reference template (e.g., reference template 1918) associated with a reference block (e.g., reference block 1920). As will be described, the existing sampling interval method has significant shortcomings (shown in FIG. 20 and FIG. 21 with more details) that may be alleviated by a coder (e.g., encoder, decoder) implemented with techniques that will be disclosed in the present disclosure.

As indicated with solid squares in FIG. 19, an encoder or decoder (also generally referred to as a video coder or coder in the present disclosure) determines a plurality of positions of candidate reference blocks 1920. As shown, each position (represented with a solid square) of candidate reference blocks 1920 indicates an upper left position (e.g., upper left corner) of each candidate reference black 1920.

In some embodiments, the coder determines a plurality of positions of candidate reference blocks 1920 that are apart from each other by a sampling interval of 3 samples in both vertical direction and horizontal direction for each search region. In this disclose, the sampling interval (e.g., subsampling interval) is also referred to as SI. As partially shown, the positions of candidate reference blocks 1920 within each search region (e.g., first TMP search region (R1), second TMP search region (R2), third TMP search region, fourth TMP search region, fifth TMP search region, sixth TMP search region) overlap with each other in both vertical and horizontal directions (creating a grid like formation or pattern when connecting them with rows and columns). For example, as shown, the positions of candidate reference blocks 1920 within third TMP search region (R3) overlap with each other in both vertical direction and horizontal direction. As shown, the positions of candidate reference blocks 1920 within fourth TMP search region (R4) overlap with each other in both vertical direction and horizontal direction. As partially shown, the positions of candidate reference blocks 1920 within first TMP search region (R1) overlap with each other in both vertical direction and horizontal direction.

The coder determines the positions of the reference blocks 1920 in first TMP search region (R1), second TMP search region (R2), third TMP search region (R3), fourth TMP search region (R4), fifth TMP search region (R5), and sixth TMP search region (R6) independently. For example, the coder determines the plurality of search regions (first TMP search region (R1), second TMP search region (R2), third TMP search region (R3), fourth TMP search region (R4), fifth TMP search region (R5), and sixth TMP search region (R6) in this example) and further determines the positions of the reference block 1920 in one search region (first TMP search region (R1) in this example) independent from (e.g., regardless of) the positions of the reference block 1920 in other search regions (second TMP search region (R2), third TMP search region (R3), fourth TMP search region (R4), fifth TMP search region (R5), and sixth TMP search region (R6) in this example). As a result, as shown, the sampling intervals between the positions of candidate reference blocks 1920 within one search region and the positions of candidate reference blocks 1920 within another neighboring search region can be less than the sampling interval of 3 samples at the boundary.

As discussed, a position of candidate reference block 1920 indicates an upper left position (e.g., upper left corner) of a corresponding candidate reference black 1920. As shown, each position of the candidate reference block 1920 is associated with a corresponding candidate reference block 1916 and a corresponding reference template 1918.

The coder searches for a matching template in each search region (first TMP search region, second TMP search region (R2), third TMP search region (R3), fourth TMP search region (R4), fifth TMP search region (R5), and sixth TMP search region (R6) in this example) based on the determined positions of candidate reference blocks 1920 (represented by the solid squares in FIG. 19). For example, as shown in FIG. 19, the coder determines 60 different positions of candidate reference blocks 1920 in fourth TMP search region (R4) and the coder determines costs (e.g., template matching costs) between a current template (associated with a current block) and candidate reference templates 1918 associated with the 60 different positions of reference blocks 1920. Likewise, as shown, the coder determines 35 different positions of candidate reference blocks 1920 in third TMP search region (R3) and the coder determines costs (e.g., template matching costs) between a current template (associated with a current block) and candidate reference templates 1918 associated with the 35 different positions of reference blocks 1920. As a result, by implementing the subsampling interval method, the amount of computation for searching for a matching reference template is reduced.

FIG. 20 and FIG. 21 illustrate the shortcomings of the subsampling interval method described in FIG. 19.

As shown in FIG. 20, since the positions of candidate reference blocks 2020 (represented by solid squares and also referred to as “sampling positions”) are determined based on the sampling interval (sampling interval of 3 in this example) in both vertical and horizontal directions, there are certain reference templates associated with rows (e.g., rows between selected rows (“sampling rows”) for positions of candidate reference blocks 2020) and certain reference templates associated with columns (e.g., columns between selected columns (“sampling columns”) for positions of candidate reference blocks 2020) are not sampled. For examples, as shown in FIG. 20, reference templates associated with (e.g., corresponding to) non-selected positions of candidate reference blocks (shown with “x” in FIG. 20) are not sampled. As a result, as shown, reference templates associated with four columns in FIG. 20 (“Non-sampled pixel columns”) and two rows in FIG. 20 (“Non-sampled pixel column”) are not sampled.

As shown in FIG. 20, a sampling interval (e.g., non-orthogonal search interval) between two positions of candidate reference blocks 2020 in a diagonal line (sampling interval of approximately 4.24 samples in this example) is greater than the sampling interval between two positions of candidate reference blocks 2020 in a horizontal line (sampling interval of 3 samples). Likewise, the sampling interval (e.g., non-orthogonal search interval) between two positions of candidate reference blocks 2020 in the diagonal line is greater than the sampling interval between two positions of candidate reference blocks 2020 in a vertical line (sampling interval of 3 samples). As a result, the sampling interval in the diagonal line in this example may not be sufficient for sampling (e.g., collecting) diverse reference templates for the template matching prediction.

As shown in FIG. 21, as discussed, the coder determines the positions of candidate reference blocks 2120 (represented by solid squares) in first TMP search region (R1), second TMP search region (R2), third TMP search region (R3), fourth TMP search region (R4), fifth TMP search region (R5), and sixth TMP search region (R6) independently. As a result, as shown, in some circumstances, the positions of candidate reference blocks 2120 in two adjacent search regions (third TMP search region (R3) and fourth TMP search region (R4) in this example) are too close to each other (e.g., less than sampling interval of 3 samples in this example). When the positions of candidate reference blocks 2120 are too close to each other, the computation of template matching prediction may increase due to over-sampling of the reference templates without a significant benefit. For instance, when the positions of the candidate reference block 2120 are too close (e.g., less than sampling interval of 3 samples in this example), it may lead to duplicated template matching computations.

For example, as shown in FIG. 21, when the coder determines that a reference template associated with a first position of candidate reference block (P1) 2120 in third TMP search region (R3) and a reference template associated with a second position of candidate reference block (P2) 2120 in fourth TMP search region (R4) are in a list of reference templates having the lowest costs (e.g., list of reference temples having a cost between the first lowest cost and the 30th lowest cost), the coder further determines costs based on reference templates associated with surrounding positions in a first refinement window (e.g., positions surrounding the first position of candidate reference block (P1) 2120 in third TMP search region (R3)) and the current template, and determines costs based on reference templates associated with surrounding positions in a second refinement window (e.g., positions surround the second position of candidate reference block (P2) 2120 in fourth TMP search region (R4) and the current template. As shown in FIG. 21, the first refinement window (3×3 window having the first position of candidate reference block (P1) 2120 at the center in this example) and the second refinement window (3×3 window having the second position of candidate reference block (P2) 2120 at the center in this example) overlap in six different positions. As a result, the coder determines template matching costs associated with the serval positions twice in the overlapped positions. As a result, the coder performs unnecessary computations.

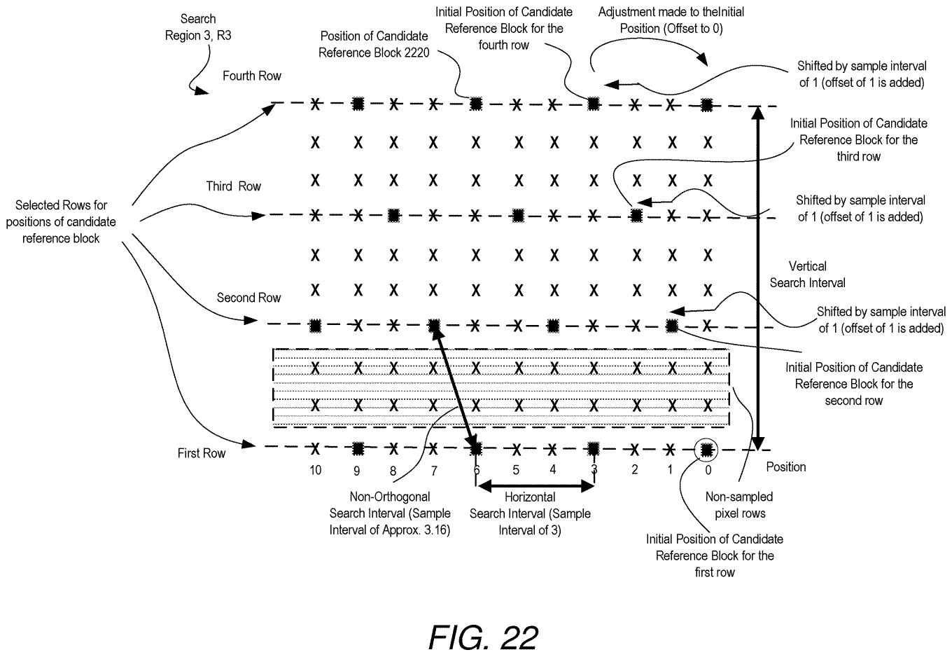

FIG. 22 illustrates an example partial third TMP search region (R3) shown with a plurality of positions of candidate reference blocks 2220 (represented by solid squares) that are arranged such that a sampling interval between two positions of candidate reference blocks 2220 in a diagonal line and a sampling interval between two positions of candidate reference blocks 2220 in a horizontal line are similar, according to some embodiments of the present disclosure. As a result, comparing with the sampling interval between two positions of candidate reference blocks 2020 in the diagonal line in FIG. 20, the sampling interval between two positions of candidate reference blocks 2220 in the diagonal line in FIG. 21 is shorter that provides greater sampling diversity (e.g., greater sampling diversity in the diagonal direction).

As shown, a coder determines rows for the positions of candidate reference blocks 2220 based on a sampling interval (sampling interval of 3 samples in a vertical direction in this example) in third TMP search region (R3). For each of the determined rows (e.g., first row from the determined rows (e.g., selected rows), second row from the determined rows (e.g., selected rows), third row from the determined row (e.g., selected rows), and fourth row from the determined rows (e.g., selected rows) in this example), the coder determines the positions of candidate reference blocks 2220 based on the sampling interval (sampling interval of 3 in a horizontal direction in this example).

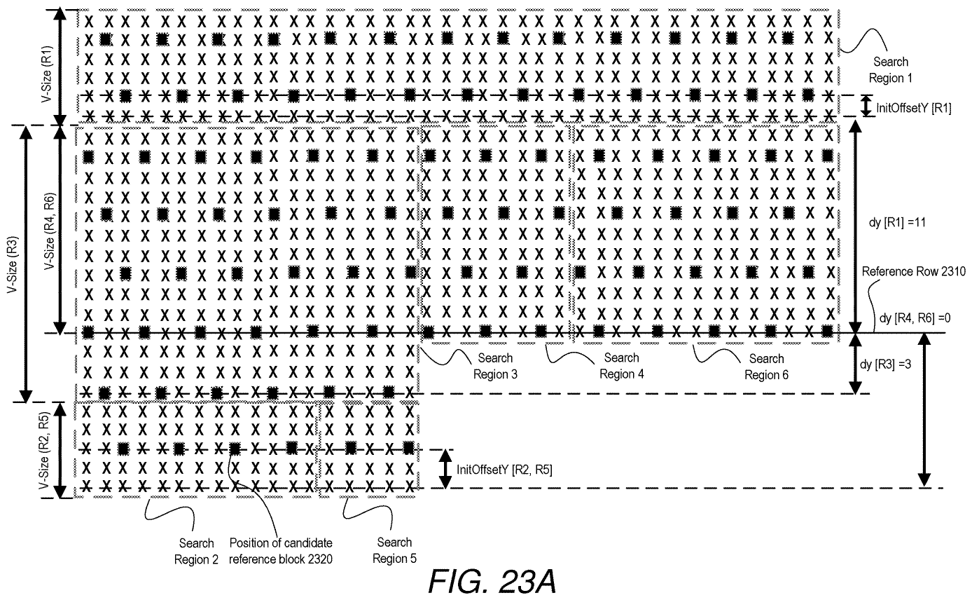

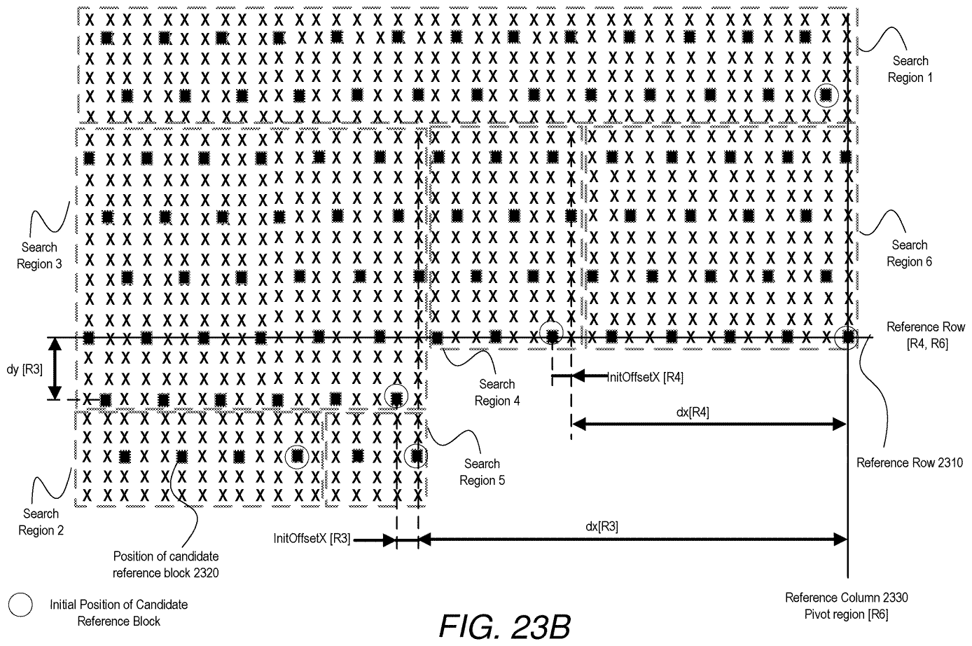

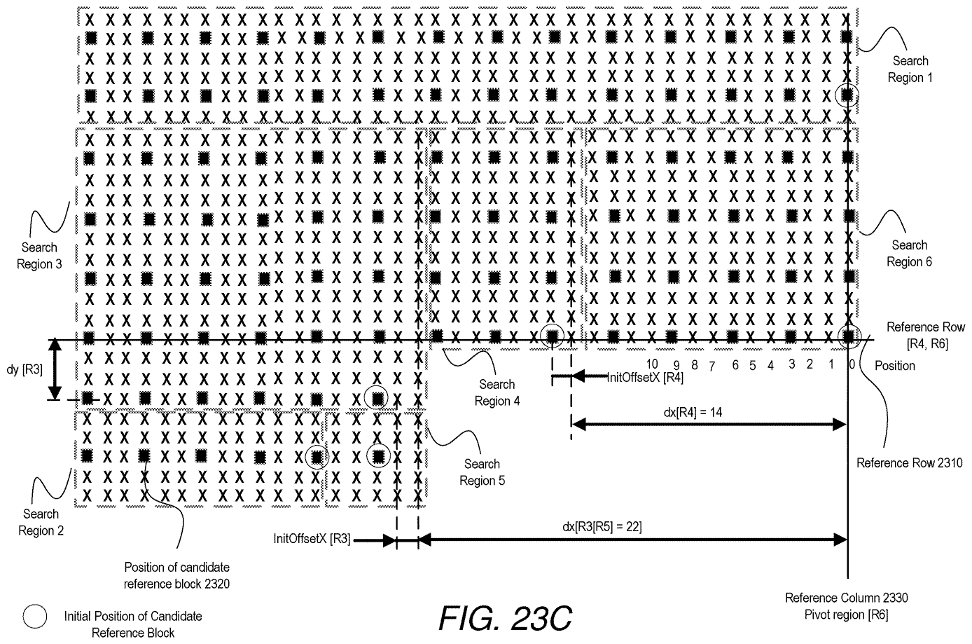

In some embodiments, the coder determines an initial position of candidate reference block 2220 in the first row (e.g., first row that is determined or selected for positions of candidate reference blocks 2220). In this example, the coder determines a first position (position 0) in the first row as the initial position of candidate reference block 2220. In some embodiments, the coder determines the initial position in a different position (e.g., position 1, position 2) in the first row. In some embodiments, the coder determines the initial position of candidate reference block 2220 regardless of the positions of candidate reference blocks 2220 in other search regions (e.g., adjacent search regions). In some embodiments, the coder determines the initial position in the first row to keep a certain distance (e.g., sampling interval) from positions of candidate reference blocks 2220 in adjacent search regions (to avoid the shortcomings described in FIG. 21). In some embodiments, the coder determines the initial position of candidate reference block 2220 in the first row in conjunction with methods (described in FIG. 23A and FIG. 23B) of determining (e.g., positioning, arranging) a plurality of positions of candidate reference blocks 2220. As a result, the plurality of positions of candidate reference blocks 2220 is consistently spread over a plurality of search regions. In some embodiments, the coder determines the initial position of candidate reference block 2220 in the first row not in conjunction with methods of determining (e.g., positioning, arranging) the plurality of positions of candidate reference blocks 2220 described in FIG. 23A and FIG. 23B to reduce implementation complexities and computations. As a result, the plurality of positions of candidate reference blocks 2220 may not consistently spread over the plurality of search regions.

In some embodiments, the coder further determines (e.g., assesses) whether to adjust (e.g., adjusting in horizontal direction, applying a horizontal offset) the initial position of candidate reference block 2220 in the first row based on a remainder of (initial position/sampling interval). In this example, the coder maintains the initial position of candidate reference block 2220 in the first row based on a remainder of 0 which indicates position 0 (remainder of 0 based on initial position of 0/sampling interval of 3 samples in this example). In some embodiments, the coder further determines other positions of candidate reference blocks 2220 in the first row based on the initial positions of candidate reference blocks 2220 (position 0 in this example) and the sampling interval (sampling interval of 3 samples in this example). As shown, based on the initial position of candidate reference block 2220 in the first row and the sampling interval of 3 samples, the coder determines the rest of positions of candidate reference blocks 2220 in the first row (position 3, position 6, position 9 . . . in this example).

In some embodiments, the coder determines an initial position of candidate reference block for the second row based on the initial position of the candidate reference block in the first row and an offset (shifting to the left direction). For example, as shown, the coder determines that the initial position of candidate reference block in the second row is position 1 based on the initial position of the candidate reference block in the first row and the offset (initial position of the candidate reference block in the first row which is position 0+offset of 1 sample in this example).

In some embodiments, the coder further determines (e.g., assesses) whether to adjust (e.g., adjusting in horizontal direction, applying horizontal offset) the initial position of candidate reference block 2220 in the second row based on a remainder of (initial position/sampling interval). In this example, the coder maintains the initial position of candidate reference block 2220 in the second row based on a remainder of 1 which indicates position 1 (remainder of 1 based on initial position of 1/sampling interval of 3 samples in this example). In some embodiments, the coder further determines other positions of candidate reference blocks 2220 in the second row based on the position of the initial position of candidate reference block 2220 (position 1 in this example) and the sampling interval (sampling interval of 3 samples in this example). As shown, based on the initial position of candidate reference block 2220 in the second row and the sampling interval of 3 samples, the coder determines the rest of positions of candidate reference blocks 2220 in the second row (position 4, position 7, position 10 . . . in this example).

In some embodiments, the coder determines an initial position of candidate reference block for the third row based on the initial position of the candidate reference block in the second row and the offset (shifting to the left direction). For example, as shown, the coder determines that the initial position of candidate reference block in the third row is position 2 based on the initial position of the candidate reference block in the second row and the offset (initial position of the candidate reference block of the second row which is position 1+offset of 1 sample in this example).

In some embodiments, the coder further determines (e.g., assesses) whether to adjust (e.g., adjusting in horizontal direction, applying horizontal offset) the initial position of candidate reference block 2220 in the third row based on a remainder of (initial position/sampling interval). In this example, the coder maintains the initial position of candidate reference block 2220 in the third row based on a remainder of 2 which indicates position 2 (remainder of 2 based on initial position of 2/sampling interval of 3 samples in this example). In some embodiments, the coder further determines other positions of candidate reference blocks 2220 in the third row based on the position of the initial positions of candidate reference blocks 2220 (position 2 in this example) and the sampling interval (sampling interval of 3 samples in this example). As shown, based on the initial position of candidate reference block 2220 in the third row and the sampling interval of 3 samples, the coder determines the rest of positions of candidate reference blocks 2220 in the third row (position 5, position 8 . . . in this example).

In some embodiments, the coder determines an initial position of candidate reference block for the fourth row based on the initial position of the candidate reference block in the third row and the offset (shifting to the left direction). For example, as shown, the coder determines that the initial position of candidate reference block in the fourth row is position 3 based on the initial position of the candidate reference block in the third row and the offset (the initial position of the candidate reference block of the third row which is position 2+offset of 1 sample in this example).

In some embodiments, the coder further determines (e.g., assesses) whether to adjust (e.g., adjusting in horizontal direction, applying horizontal offset) the initial position of candidate reference block 2220 in the fourth row based on a remainder of (initial position/sampling interval). In this example, the coder determines that the initial position of candidate reference block 2220 in the fourth row to be adjusted to position 0 based on a remainder of 0 which indicates position 0 (remainder of 0 based on initial position of 3/sampling interval of 3 samples in this example). As a result, the coder adjusts the initial position of candidate reference block in the fourth row to position 0 in this example. In some embodiments, the coder further determines other positions of candidate reference blocks 2220 in the fourth row based on the position of the (adjusted) initial positions of candidate reference blocks 2220 (position 0 in this example) and the sampling interval (sampling interval of 3 in this example).

Based on the method described above, as shown, the positions of candidate reference blocks 2220 in the first row non-overlap (e.g., non-overlapping in the vertical direction) with the positions of candidate reference blocks 2220 in the second row. Likewise, as shown, the positions of candidate reference blocks 2220 in the second row non-overlap (e.g., non-overlapping in the vertical direction) with the positions of candidate reference blocks 2220 in the third row. Also, as shown, the positions of candidate reference blocks 2220 in the third row non-overlap (e.g., non-overlapping in the vertical direction) with the positions of candidate reference blocks 2220 in the fourth row. In other words, positions of candidate reference blocks 2220 in one row non-overlap (e.g., non-overlapping in the vertical direction) with positions of candidate reference blocks 2220 in an adjacent row/adjacent rows. As a result, the positions of candidate reference blocks 2220 in FIG. 22 non-align in the vertical direction and provide greater sampling diversity compared to the positions of candidate reference blocks 2020 shown in FIG. 20.

As shown, comparing to the sampling interval between two positions of candidate reference blocks 2020 in the diagonal line (sample interval of approx. 4.2 samples) in FIG. 20 and the sampling interval between two positions of candidate reference blocks 2020 in the horizontal line (sample interval of 3 samples) in FIG. 20, the difference between the sampling interval of two positions of candidate reference blocks 2220 in the diagonal line in FIG. 22 (sample interval of approx. 3.16 samples) and the sampling interval between two positions of candidate reference blocks 2220 in the horizontal line in FIG. 22 (sampling interval of 3 samples) is smaller. As a result, methods described in FIG. 22 may alleviate the shortcomings of the existing technology by providing greater sampling diversity (e.g., greater sampling diversity in the diagonal direction). Further, by shifting (e.g., adding offset to) the initial position of candidate reference block 2220 for the second row, third row, etc., the coder can easily obtain sampling diversity greater than the initial sampling diversity.

FIG. 23A and FIG. 23B illustrate a plurality of positions of candidate reference blocks 2320 consistently spread over a plurality of search regions (first TMP search region (R1), second TMP search region (R2), third TMP search region (R3), fourth TMP search region (R4), fifth TMP search region (R5) and sixth TMP search region (R6) in this example), according to some embodiments.

As discussed above, in existing technology, the coder determines the positions of candidate reference blocks for one search region independent from the positions of candidate reference blocks in other search regions (e.g., adjacent search regions). As a result, as shown in FIG. 21, in some circumstances, the positions of the candidate reference block 2120 in two adjacent search regions (third TMP search region (R3) and fourth TMP search region (R4) in this example) may be too close to each other (e.g., less than sampling interval of 3 samples).

As shown in FIG. 23A and FIG. 23B, in some embodiments, a coder determines the positions of candidate reference blocks 2320 based on a reference row 2310 (shown in FIG. 23A and FIG. 23B) and a reference column 2330 (shown in FIG. 23B). As a result, all of the positions for candidate reference blocks 2320 are consistently spread over the plurality of search regions (first TMP search region (R1), second TMP search region (R2), third TMP search region (R3), fourth TMP search region (R4), fifth TMP search region (R5) and sixth TMP search region (R6) in this example)—maintaining a certain distance from each other (e.g., sampling interval in a horizontal direction, (sampling) interval between selected rows, sampling interval in a vertical direction).

In some embodiments, as shown in FIG. 23A, the coder determines the reference row 2310 and determines a first row for the positions of candidate reference blocks 2320 for each search region based on a distance (in a vertical direction) between the reference row 2310 and a first row (e.g., bottom row) of each search region.

In some embodiments, as shown in FIG. 23A, the coder determines the reference row 2310. In some embodiments, the coder determines a first distance (dy[R1]=11 samples in this example) between a first row (e.g., bottom row) of first TMP search region (R1) and the reference row 2310, a second distance (dy[R2]=8 samples in this example) between a first row (e.g., bottom row) of second TMP search region (R2) and the reference row 2310, a third distance (dy[R3]=3 samples in this example) between a first row (e.g., bottom row) of third TMP search region (R3) and the reference row 2310, a fourth distance (dy[R4]=0 in this example) between a first row (e.g., bottom row) of fourth TMP search region (R4) and the reference row 2310, a fifth distance (dy[R5]=8 in this example) between a first row (e.g., bottom row) of fifth TMP search region (R5) and the reference row 2310, and a sixth distance (dy[R6]=0 in this example) between a first row (e.g., bottom row) of sixth TMP search region (R6) and the reference row 2310.

In some embodiments, for a search region with 0 distance dy (fourth TMP search region (R4) and sixth TMP search region (R6) in this example), the coder determines that the first row of the search region is the first row for the positions of candidate reference blocks 2320. (Initial offset Y [R4] and Initial offset Y [R6]=0) In other words, for the search region with 0 distance dy, the coder maintains that the first row (e.g., bottom row) of the search region as the first row for positions of candidate reference blocks 2320. As a result, in this example, the coder determines that the first row (e.g., bottom row) of fourth TMP search region (R4) is the first row for positions of candidate reference blocks 2320 and the first row (e.g., bottom row) of sixth TMP search region (R6) is the first row for positions of candidate reference blocks 2320.

In some embodiments, for a search region with a first row (e.g., bottom row) above the reference row 2310 (first TMP search region (R1) in this example), the coder determines the first row for positions of candidate reference blocks 2320 based on the distance dy and the sampling interval using a following equation:

$$Initial offset Y [ Ri ] = ( SI - ( distance dy \% SI ) ) \% SI \qquad ( 21 )$$

where the Initial offset Y [Ri] is an offset value indicating a distance between the first row (e.g., bottom row) and the first row for the positions of candidate reference blocks 2320. For example, the coder determines Initial offset Y [R1] for first TMP search region (R1) by determining (e.g., computing) a remainder of (sampling interval of 3 samples-remainder of (11/sampling interval of 3 samples)/sampling interval 3 samples. As a result, for first TMP search region (R1), the coder determines the Initial offset Y [R1]=1. Accordingly, the first row for positions of candidate reference blocks 2320 in first TMP search region (R1) is the second row of first TMP search region (R1) (first row+Initial offset Y of 1=second row).

In some embodiments, for a search region with a first row (e.g., bottom row) below the reference row (second TMP search region (R2), third TMP search region (R3) and fifth TMP search region (R5) in this example), the coder determines a first row for positions of candidate reference blocks 2320 based on the distance dy and the sampling interval using a following equation:

$$Initial offset Y [ Ri ] = ( distance dy \% SI ) \qquad ( 22 )$$

where the Initial offset Y [Ri] is an offset value indicates a distance between the first row (e.g., bottom row) and the first row for the positions of candidate reference blocks 2320. For example, the coder determines Initial offset Y [R2] for second TMP search region (R2), by determining (e.g., computing) a remainder of (8/sampling interval of 3 samples). As a result, for second TMP search region (R2), the coder determines the Initial offset Y [R2]=2. Accordingly, the first row for positions of candidate reference blocks 2320 in second TMP search region (R2) is the third row of second TMP search region (R2) (first row+Initial offset Y of 2=third row).

Likewise, for example, the coder determines Initial offset Y [R3] for third TMP search region (R3), by determining (e.g., computing) a remainder of (3/sampling interval of 3 samples). As a result, for third TMP search region (R3), the coder determines the Initial offset Y [R3]=0. Accordingly, the first row for positions of candidate reference blocks 2320 in third TMP search region (R3) is the first row of third TMP search region R3 (first row+Initial offset Y of 0=first row).

Similarly, for example, the coder determines Initial offset Y [R5] for fifth TMP search region (R5), by determining (e.g., computing) a remainder of (8/sampling interval of 3 samples). As a result, for fifth TMP search region (R5), the coder determines the Initial offset Y [R5]=2. Accordingly, the first row for positions of candidate reference blocks 2320 in fifth TMP search region (R5) is the third row of the R5 (first row+Initial offset Y of 2=third row).

In some embodiments, as shown in FIG. 23B, the coder determines a reference column 2330 and determines a column of an initial position of candidate reference block for each search region based on the sampling interval and a distance dx (in the horizontal direction) between the reference column and a first column (e.g., column on the far-right side) of each search region.

In some embodiments, as shown in FIG. 23B, the coder determines the reference column 2330. In some embodiments, the coder determines a first distance (dx[R1]=0 sample in this example) between the first column (e.g., column on the far-right side) of first TMP search region (R1) and reference column 2330, a second distance (dx[R2]=27 samples in this example) between the first column (e.g., column on the far-right side) of second TMP search region (R2) and reference column 2330, a third distance (dx[R3]=22 samples in this example) between the first column (e.g., column on the first-right side) of the third TMP search region (R3) and reference column 2330, a fourth distance (dx[R4]=14 samples in this example) between the first row (e.g., column on the far-right side) of fourth TMP search region (R4) and reference column 2330, a fifth distance (dx[R5]=22 samples in this example) between the first column (e.g., column on the far-right side) of fifth TMP search region (R5) and reference column 2330, and a sixth distance (dx[R6]=0 sample in this example) between the first column (e.g., column on the far-right side) of sixth TMP search region (R6) and reference column 2330.

In some embodiments, for a search region having a first row (e.g., bottom row) aligned with the reference row 2310 (fourth TMP search region (R4) and sixth TMP search region (R6) in this example), the coder determines a column for an initial position of candidate reference block 2320 based on the distance dx and the sampling interval using following equation:

$$Initial offset X [ Ri ] = ( SI - ( distance dx \% SI ) ) \% SI \qquad ( 23 )$$

where the Initial offset X [Ri] is an offset value indicating a distance between the first column (e.g., column on the far-right side) and the column for the initial position of candidate reference block 2320. For example, the coder determines Initial offset X [R4] for fourth TMP search region (R4), by determining (e.g., computing) a remainder of (sampling interval of 3 samples-(remainder of 14/sampling interval of 3 samples))/sampling interval of 3 samples. As a result, for fourth TMP search region (R4), the coder determines the Initial offset X [R4]=1. Accordingly, the initial position of candidate reference block 2320 for fourth TMP search region (R4) is shifted by one sample (Initial offset X [R4]=1) to the left from the column on the far-right side of fourth TMP search region (R4). In some embodiments, based on the Initial offset Y [R4] and the Initial offset X [R4], the encoder or decoder determines the initial position of candidate reference block in the first determined row and further determines other positions of candidate reference blocks in fourth TMP search region (R4) as discussed in FIG. 22 (applying the offset to the second row, third row, fourth row . . . Nth row).

Likewise, for example, the coder determines Initial offset X [R6] for sixth TMP search region (R6), by determining (e.g., computing) a remainder of (sampling interval of 3 samples-(remainder of 0/sampling interval of 3 samples))/sampling interval of 3 samples. As a result, for sixth TMP search region (R6), the coder determines the Initial offset X [R6]=0. Accordingly, the initial position of candidate reference block 2320 for sixth TMP search region (R6) is on the first column (e.g., the column on far-right side of sixth TMP search region (R6). In some embodiments, based on the Initial offset Y [R6] and the Initial offset X [R6], the encoder or decoder determines the initial position of candidate reference block in the first determined row and further determines other positions of candidate reference blocks in sixth TPM search region (R6) as discussed in FIG. 22 (applying the offset to the second row, third row, fourth row . . . Nth row).

In some embodiments, for a search region having a first row (e.g., bottom row) below the reference row 2310 (second TMP search region (R2), third TMP search region (R3), fifth TMP search region (R5) in this example), the coder determines a column for an initial position of candidate reference block 2320 based on the distance dx and sampling interval using following equation:

$$Initial offset X [ Ri ] = ( Initial Offset {X}^{′} [ Ri ] - ( \frac{{dy [ Ri ]}^{′}}{SI} ) \% SI + SI ) \% SI \qquad ( 24 )$$

$$Initial Offset {X}^{′} [ Ri ] = ( SI - ( dx \% SI ) ) \% SI$$

In the above equation, dy[Ri]′ is a distance between the reference row and the first row for the positions of candidate reference blocks, for TMP search region [Ri], determined in FIG. 23A. For example, the coder determines a column for the initial position of candidate reference block 2320 based on computations shown below.

$$Intial Offset X [ R 2 ] = ( ( 3 - ( 27 \% 3 ) ) \% 3 - ( \frac{6}{3} ) \% 3 + 3 ) \% 3 = ( 0 - 2 + 3 ) \% 3 = 1$$

$$Initlal Offset X [ R 3 ] = ( ( 3 - ( 22 \% 3 ) ) \% 3 - ( \frac{3}{3} ) \% 3 + 3 ) \% 3 = ( 2 - 1 + 3 ) \% 3 = 1$$

$$Intial Offset X [ R 5 ] = ( ( 3 - ( 22 \% 3 ) ) \% 3 - ( \frac{6}{3} ) \% 3 + 3 ) \% 3 = ( 2 - 2 + 3 ) = 0$$

Accordingly, the initial position of candidate reference block 2320 for second TMP search region (R2) is shifted by one sample (Initial offset X [R2]=1) to the left from the column on the far-right side of second TMP search region (R2). Likewise, the initial position of candidate reference block 2320 for third TMP search region (R3) is shifted by one sample (Initial offset X [R3]=1) to the left from the column on the far-right side of third TMP search region (R3). In this example, since Initial offset [R5] is 0, the initial position of candidate reference block 2320 for fifth TMP search region (R5) remains in the column on the far-right side of fifth TMP search region (R5).

In some embodiments, based on the Initial offset Y [R2] and the Initial offset X [R2], the coder determines the initial position of candidate reference block and further determines other positions of candidate reference blocks in first TMP search region (R2) as discussed in FIG. 22 (applying the offset to the second row, third row, fourth row . . . Nth row).

In some embodiments, based on the Initial offset Y [R3] and the Initial offset X [R3], the encoder or decoder determines the initial position of candidate reference block and further determines other positions of candidate reference blocks in third TMP search region (R6) as discussed in FIG. 22 (applying the offset to the second row, third row, fourth row . . . Nth row).

In some embodiments, based on the Initial offset Y [R5] and the Initial offset X [R5], the encoder or decoder determines the initial position of candidate reference block and further determines other positions of candidate reference blocks in fifth TMP search region (R5) as discussed in FIG. 22 (applying the offset to the second row, third row, fourth row . . . Nth row).

In some embodiments, for a search region having a first row (e.g., bottom row) above the reference row 2310 (first TMP search region (R1) in this example), the coder determines a column for an initial position of candidate reference block 2320 based on the distance dx and sampling interval using following equation:

$$Initial offset X [ Ri ] = ( Initial Offset {X}^{′} [ Ri ] + ( \frac{{dy [ Ri ]}^{′}}{SI} ) \% SI + SI ) \% SI \qquad ( 25 )$$

$$Initial Offset {X}^{′} [ Ri ] = ( SI - ( dx \% SI ) ) \% SI$$

In the above equation, dy[Ri]′ is a distance between the reference row and the first row for the positions of candidate reference blocks, for the search region, determined in FIG. 23A. For example, the coder determines a column for the initial position of candidate reference block 2320 based on calculations shown below.

$$Initial Offset X [ R 1 ] = ( ( 3 - ( 0 \% 3 ) ) \% 3 + ( \frac{12}{3} ) \% 3 + 3 ) \% 3 = ( 0 + 1 + 3 ) \% 3 = 1$$

Accordingly, the initial position of candidate reference block 2320 for first TMP search region (R1) is shifted by one sample (Initial offset X [R1]=1) from the column on the far-right side of first TMP search region (R1). In some embodiments, based on the Initial offset Y [R1] and the Initial offset X [R1], the coder determines the initial position of candidate reference block and further determines other positions of candidate reference blocks in first TMP search region (R1) as discussed in FIG. 22 (applying the offset to the second row, third row, fourth row . . . Nth row).

The present disclosure (including in FIG. 22, FIG. 23A and FIG. 23B), provides serval examples of arranging the plurality of positions of candidate reference blocks using the sampling interval of 3 samples (e.g., sampling interval of 3 samples in a vertical direction, sampling interval of 3 samples in a horizontal direction). However, in some embodiments, the coder determines the plurality of positions of candidate reference block based on a sampling interval of 2 samples. In some embodiments, the coder determines the plurality of positions of candidate reference block based on a sampling interval of 4 samples or greater.

FIG. 23C illustrates a plurality of positions of candidate reference blocks 2320 consistently spread (e.g., arranged uniformly, arranged evenly) over a plurality of search regions (first TMP search region (R1), second TMP search region (R2), third TMP search region (R3), fourth TMP search region (R4), fifth TMP search region (R5) and sixth TMP search region (R6) in this example) without applying offsets, according to some embodiments.

As shown in FIG. 23C, in some embodiments, a coder determines the positions of candidate reference blocks 2320 based on a reference row 2310 (also shown in FIG. 23A and FIG. 23B) and a reference column 2330 (also shown in FIG. 23B). As a result, all of the positions for candidate reference blocks 2320 are consistently spread over the plurality of search regions (first TMP search region (R1), second TMP search region (R2), third TMP search region (R3), fourth TMP search region (R4), fifth TMP search region (R5) and sixth TMP search region (R6) in this example)—maintaining a certain distance from each other (e.g., sampling interval in a horizontal direction, (sampling) interval between selected rows, sampling interval in a vertical direction).

In some embodiments, as shown in FIG. 23C, the coder determines the reference row 2310 and determines a first row for the positions of candidate reference blocks 2320 for each search region based on a distance (in a vertical direction) between the reference row 2310 and a first row (e.g., bottom row) of each search region.

In some embodiments, the coder determines Initial offset Y [Ri] to determine the first row for each search region. Since Initial offset Y [R1] for first TMP search region (R1), Initial offset Y [R2] for second TMP search region (R2), Initial offset Y [R3] for third TMP search region (R3), Initial offset Y [R4] for fourth TMP search region (R4), Initial offset Y [R5] for fifth TMP search region (R5), and Initial offset Y [R6] for sixth TMP search region (R6) are determined in the similar way as discussed in FIG. 23A, the detail computation of determining the first row for the positions of candidate reference blocks 2320 for each search region is not repeated here.

In some embodiments, as shown in FIG. 23C, the coder determines a reference column 2330 and determines a column of an initial position of candidate reference block for each search region based on the sampling interval and a distance dx (in the horizontal direction) between the reference column and a first column (e.g., column on the far-right side) of each search region.

In some embodiments, as shown in FIG. 23C, the coder determines the reference column 2330. In some embodiments, the coder determines a first distance (dx[R1]=0 sample in this example) between the first column (e.g., column on the far-right side) of first TMP search region (R1) and reference column 2330, a second distance (dx[R2]=27 samples in this example) between the first row (e.g., column on the far-right side) of second TMP search region (R2) and reference column 2330, a third distance (dx[R3]=22 samples in this example) between the first column (e.g., column on the first-right side) of the third TMP search region (R3) and reference column 2330, a fourth distance (dx[R4]=14 samples in this example) between the first column (e.g., column on the far-right side) of fourth TMP search region (R4) and reference column 2330, a fifth distance (dx[R5]=22 samples in this example) between the first column (e.g., column on the far-right side) of fifth TMP search region (R5) and reference column 2330, and a sixth distance (dx[R6]=0 sample in this example) between the first column (e.g., column on the far-right side) of sixth TMP search region (R6) and reference column 2330.

In some embodiments, for a search region having a first column (e.g., column on the far-right side) aligned with the reference column 2330 (first TMP search region (R1) and sixth TMP search region (R6) in this example), the coder determines the first column for an initial position of candidate reference block 2320. Accordingly, Initial offset X [R1] and Initial offset X [R6] are equal to 0.

As shown, for first TMP search region (R1), the coder determines the initial position of candidate reference block 2320 based on Initial offset Y [R1]=1 and Initial offset X [R1]=0. In some embodiments, based on the initial position of candidate reference block 2320 and the sampling interval (sampling interval of 3 sample in this example), the encoder or decoder determines other positions of candidate reference blocks in first TMP search region (R1).

As shown, for sixth TMP search region (R6), the coder determines the initial position of candidate reference block 2320 based on Initial offset Y [R6]=0 and Initial offset X [R6]=0. In some embodiments, based on the initial position of candidate reference block 2320 and the sampling interval (sampling interval of 3 sample in this example), the encoder or decoder determines other positions of candidate reference blocks in sixth TMP search region (R6).

In some embodiments, for a search region having a first column (e.g., column on the far-right side) non-aligned with the reference column 2330, the coder determines a column for an initial position of candidate reference block 2320 based on the distance dx and the sampling interval using following equation:

$$Initial offset X [ Ri ] = ( SI - ( distance dx \% SI ) ) \% SI \qquad ( 26 )$$

where the Initial offset X [Ri] is an offset value indicating a distance between the first column (e.g., column on the far-right side) and the column for the initial position of candidate reference block 2320. For example, the coder determines Initial offset X [R4] for fourth TMP search region (R4), by determining (e.g., computing) a remainder of (sampling interval of 3 samples-(remainder of 14/sampling interval of 3 samples)/sampling interval of 3 samples. As a result, for fourth TMP search region (R4), the coder determines the Initial offset X [R4]=1. Accordingly, the initial position of candidate reference block 2320 for fourth TMP search region (R4) is shifted by one sample (Initial offset X [R4]=1) to the left from the column on the far-right side of fourth TMP search region (R4). In some embodiments, based on the Initial offset Y [R4]=0 and the Initial offset X [R4], the encoder or decoder determines the initial position of candidate reference block in the first determined row and further determines other positions of candidate reference blocks in fourth TMP search region (R4) based on the sampling interval (e.g., sampling interval of 3 samples).

Likewise, for example, the coder determines Initial offset X [R3] for third TMP search region (R3), by determining (e.g., computing) a remainder of (sampling interval of 3 samples-(remainder of 22/sampling interval of 3 samples)/sampling interval of 3 samples. As a result, for third TMP search region (R3), the coder determines the Initial offset X [R3]=2. Accordingly, the initial position of candidate reference block 2320 for third TMP search region (R3) is shifted by two samples (Initial offset X [R3]=2) to the left from the column on the far-right side of third TMP search region (R3). In some embodiments, based on the Initial offset Y [R3]=0 and the Initial offset X [R3], the encoder or decoder determines the initial position of candidate reference block in the first determined row and further determines other positions of candidate reference blocks in third TMP search region (R3) based on the sampling interval (e.g., sampling interval of 3 samples).

Likewise, for example, the coder determines Initial offset X [R5] for fifth TMP search region (R5), by determining (e.g., computing) a remainder of (sampling interval of 3 samples-(remainder of 22/sampling interval of 3 samples)/sampling interval of 3 samples. As a result, for fifth TMP search region (R5), the coder determines the Initial offset X [R5]=2. Accordingly, the initial position of candidate reference block 2320 for fifth TMP search region (R5) is shifted by two samples (Initial offset X [R5]=2) to the left from the column on the far-right side of fifth TMP search region (R5). In some embodiments, based on the Initial offset Y [R5]=2 and the Initial offset X [R5], the encoder or decoder determines the initial position of candidate reference block in the first determined row and further determines other positions of candidate reference blocks in fifth TMP search region (R5) based on the sampling interval (e.g., sampling interval of 3 samples).

Likewise, for example, the coder determines Initial offset X [R2] for second TMP search region (R2), by determining (e.g., computing) a remainder of (sampling interval of 3 samples-(remainder of 27/sampling interval of 3 samples))/sampling interval of 3 samples. As a result, for second TMP search region (R2), the coder determines the Initial offset X [R2]=0. Accordingly, the initial position of candidate reference block 2320 for second TMP search region (R2) is shifted by 0 sample (Initial offset X [R2]=0) to the left from the column on the far-right side of fifth TMP search region (R5). In some embodiments, based on the Initial offset Y [R2]=2 and the Initial offset X [R2], the encoder or decoder determines the initial position of candidate reference block in the first determined row and further determines other positions of candidate reference blocks in second TMP search region (R2) based on the sampling interval (e.g., sampling interval of 3 samples).

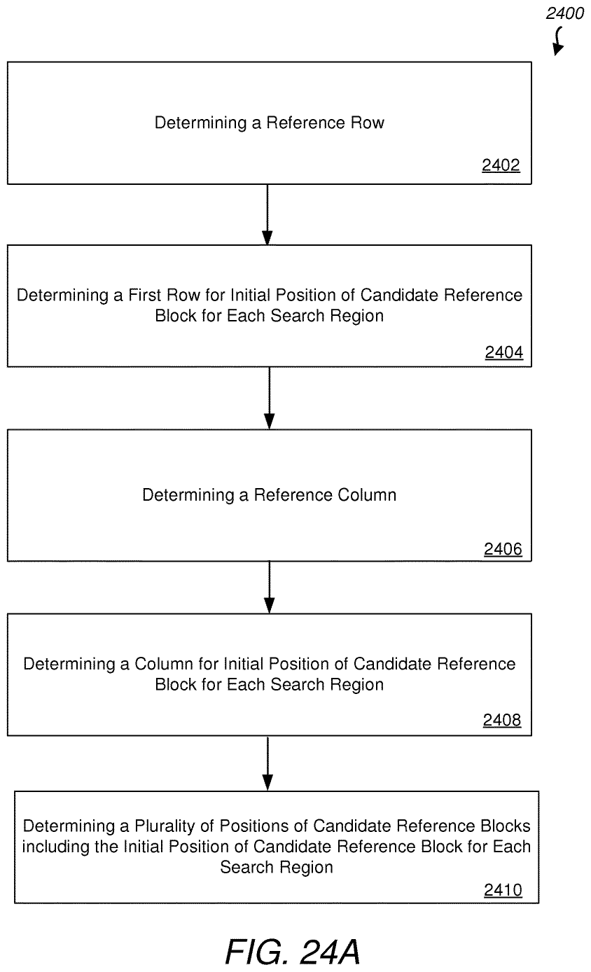

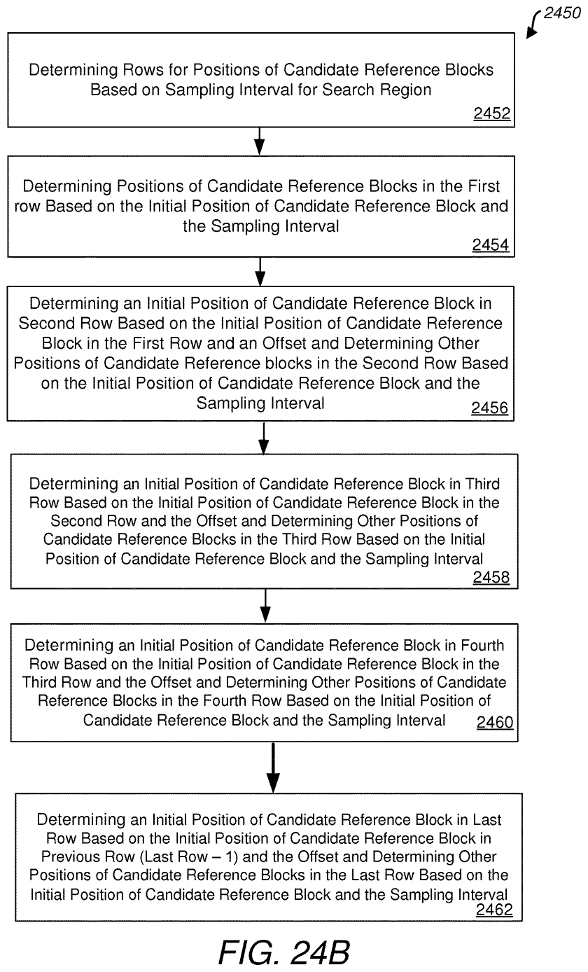

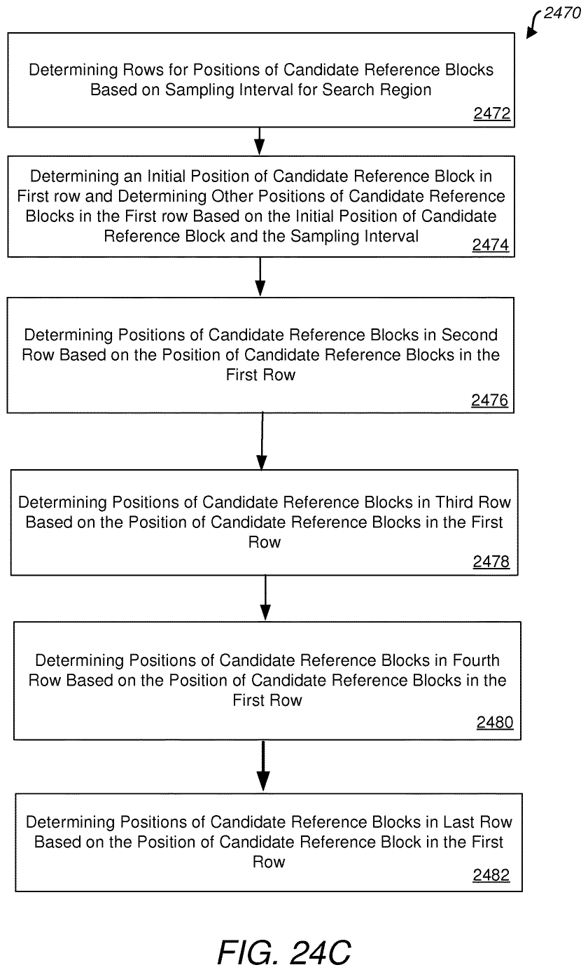

FIG. 24A shows an example flowchart of method 2400 of determining a plurality of positions of candidate reference blocks such that the positions of candidate reference blocks are consistently spread over a plurality of search regions, according to some embodiments of the present disclosure. The method 2400 may be performed by a coder (e.g., processing logic) that may include hardware (circuitry, dedicated logic, one or more processor, etc.), software (such as is run on a general purpose computer system or a dedicated machine), or a combination of both, which the coder may be included in any computer system or device. For simplicity of explanation, methods described herein are depicted and described as a series of operations. However, operations in accordance with this disclosure may occur in various orders and/or concurrently, and with other operations not presented and described herein. Further, not all illustrated operations may be used to implement the methods in accordance with the disclosed subject matter. In addition, those skilled in the art will understand and appreciate that the methods may alternatively be represented as a series of interrelated states via a state diagram or events. Additionally, the methods disclosed in this specification are capable of being stored on an article of manufacture, such as a non-transitory computer-readable medium, to facilitate transporting and transferring such methods to computing devices. The term article of manufacture, as used herein, is intended to encompass a computer program accessible from any computer-readable device or storage media. Although illustrated as discrete blocks, various blocks may be divided into additional blocks, combined into fewer blocks, or eliminated, depending on the desired implementation.

At 2402, the coder determines (e.g., selects) a reference row. As discussed, the coder determines a first row for an initial position of candidate reference block for each search region based on a distance (in a vertical direction) between the reference row and a first row (e.g., bottom row) of each search region and a sampling interval (e.g., sampling interval of 3 samples).

At 2404, the coder determines the first row for the initial position of candidate reference block for each search region.

At 2406, the coder determines (e.g., selects) a reference column. As discussed, the coder determines a first column for the initial position of candidate reference block for each search region based on a distance (in a horizontal direction) between the reference column and a first column (e.g., column on the far-right side) of each search region and the sampling interval (e.g., sampling interval of 3 samples).

At 2408, the coder determines the first column for the initial position of candidate reference block for each search region.

At 2410, the coder determines a plurality of positions of candidate reference blocks including the initial position of candidate reference block for each search region. As discussed, the coder determines the initial position of candidate reference block for each search region. As discussed, the coder determines the rest of the positions of candidate reference blocks based on the initial position of the candidate reference block in each search region.

FIG. 24B shows an example flowchart of method 2450 of arranging a plurality of positions of candidate reference blocks that are arranged such that a sampling interval between two positions of candidate reference blocks in a diagonal line and a sampling interval between two positions of candidate reference blocks in a horizontal line are similar, according to some embodiments of the present disclosure. The method 2450 may be performed by a coder (e.g., processing logic) that may include hardware (circuitry, dedicated logic, one or more processor, etc.), software (such as is run on a general purpose computer system or a dedicated machine), or a combination of both, which the coder may be included in any computer system or device. For simplicity of explanation, methods described herein are depicted and described as a series of operations. However, operations in accordance with this disclosure may occur in various orders and/or concurrently, and with other operations not presented and described herein. Further, not all illustrated operations may be used to implement the methods in accordance with the disclosed subject matter. In addition, those skilled in the art will understand and appreciate that the methods may alternatively be represented as a series of interrelated states via a state diagram or events. Additionally, the methods disclosed in this specification are capable of being stored on an article of manufacture, such as a non-transitory computer-readable medium, to facilitate transporting and transferring such methods to computing devices. The term article of manufacture, as used herein, is intended to encompass a computer program accessible from any computer-readable device or storage media. Although illustrated as discrete blocks, various blocks may be divided into additional blocks, combined into fewer blocks, or eliminated, depending on the desired implementation.

At 2452, for each search region, the coder determines rows (e.g., second row, third row, fourth row . . . last row) for positions of candidate reference blocks based on a determined first row (e.g., first row in FIG. 24A) and a sampling interval (shifting to the upper direction). For example, the coder determines the second row based on the first row+sampling interval of 3 samples in the vertical direction. In some embodiments, the coder determines the third row based on the second row+sampling interval of 3 samples. In some embodiments, the coder determines the third row based on the first row+ (2×sampling interval of 3 samples). In some embodiments, the coder determines the fourth row based on the third row+sampling interval of 3 samples. In some embodiments, the coder determines the fourth row based on the first row+ (3×sampling interval of 3 samples). As a result, for each search region, the coder selects rows that are N×sampling interval away in the upper direction from the determined first row (e.g., N=1 for the second row, N=2 for the third row, N=3 for the fourth row . . . ).

At 2454, for the first row, the coder determines additional positions of candidate reference blocks based on a determined initial position of candidate reference block in the first row (e.g., initial position of candidate reference block in FIG. 24A, predetermined position such as position 0, position 1, or position 2) and the sampling interval (shifting to the left direction). For example, the coder selects the additional positions of candidate reference blocks in the first row that are N×sampling interval away in the left direction from the initial position of candidate reference block in the first row. As a result, when the initial position of candidate reference block for the first row is at position 0, the additional positions of candidate reference blocks are at a plurality of positions including position 3 (=0+3), position 6 (=0+ (3×2)), and position 9=(0+(3×3) as shown in FIG. 22. In some embodiments, when the initial position of candidate reference block for the first row is at position 0, the additional positions of candidate reference blocks are at plurality of positions including position 3 (=0+3), position 6 (=position 3+3), and position 9 (=position 6+3) as shown in FIG. 22.

At 2456, the coder determines an initial position of candidate reference block in the second row based on the initial position of candidate reference block in the first row and the offset (offset of 1 sample in this example). For example, the coder determines the initial position of candidate reference block for the second row based on the initial position of candidate reference block in the first row that is shifted to the left direction by the offset. For example, when the initial position of candidate reference block in the first row is at position 0, the initial position of candidate reference block in the second row is at position 1 (=position 0+offset of 1) as shown in FIG. 22. In some embodiments, the coder further determines additional positions of candidate reference blocks in the second row based on the initial position of the candidate reference block in the second row and sampling interval (sampling interval of 3 sample in this example). For example, the coder selects the additional positions of candidate reference blocks in the second row that are N×sampling interval away in the left direction from the initial position of candidate reference block in the second row. As a result, when the initial position of candidate reference block for the second row is at position 1, the additional positions of candidate reference blocks are at a plurality of positions including position 4 (=1+3), position 7 (=1+ (3×2), and position 10=(1+(3×3) as shown in FIG. 22. In some embodiments, when the initial position of candidate reference block for the second row is at position 1, the additional positions of candidate reference blocks are at plurality of positions including position 4 (=1+3), position 7 (=position 4+3), and position 10 (=position 7+3) as shown in FIG. 22.

At 2458, the coder determines an initial position of candidate reference block in the third row based on the initial position of candidate reference block in the second row and the offset (offset of 1 sample in this example). For example, the coder determines the initial position of candidate reference block for the third row based on the initial position of candidate reference block in the second row that is shifted to the left direction by the offset. For example, when the initial position of candidate reference block in the second row is at position 1, the initial position of candidate reference block in the third row is at position 2 (=position 1+offset of 1) as shown in FIG. 22. In some embodiments, the coder further determines additional positions of candidate reference blocks in the third row based on the initial position of the candidate reference block in the third row and sampling interval (sampling interval of 3 sample in this example). For example, the coder selects the additional positions of candidate reference blocks in the third row that are N×sampling interval away in the left direction from the initial position of candidate reference block in the third row. As a result, when the initial position of candidate reference block for the third row is at position 2, the additional positions of candidate reference blocks are at a plurality of positions including position 5 (=2+3), and position 8 (=2+(3×2) as shown in FIG. 22. In some embodiments, when the initial position of candidate reference block for the third row is at position 2, the additional positions of candidate reference blocks are at plurality of positions including position 5 (=2+3), and position 8 (=position 5+3) as shown in FIG. 22.

At 2460, the coder determines an initial position of candidate reference block in the fourth row based on the initial position of candidate reference block in the third row and the offset (offset of 1 sample in this example). For example, the coder determines the initial position of candidate reference block for the fourth row based on the initial position of candidate reference block in the third row that is shifted to the left direction by the offset. For example, when the initial position of candidate reference block in the third row is at position 2, the initial position of candidate reference block in the fourth row is at position 3 (=position 2+offset of 1) as shown in FIG. 22. As discussed in FIG. 22, in some embodiments, the coder further determines (e.g., assesses) whether to adjust (e.g., adjusting in horizontal direction, applying horizontal offset) the initial position of candidate reference block 2220 in the fourth row based on a remainder of (initial position/sampling interval). In this example, the coder determines that the initial position of candidate reference block in the fourth row to be adjusted to position 0 based on a remainder of 0 which indicates position 0 (remainder of 0 based on initial position of 3/sampling interval of 3 samples in this example). As a result, the coder adjusts the initial position of candidate reference block in the fourth row to position 0 in this example. As discussed, the coder may perform this assessment step for each row.

In some embodiments, the coder further determines additional positions of candidate reference blocks in the fourth row based on the initial position of the candidate reference block (that is adjusted to position 0 in this example) in the fourth row and sampling interval (sampling interval of 3 sample in this example). For example, the coder selects the additional positions of candidate reference blocks in the fourth row that are N×sampling interval away in the left direction from the initial position of candidate reference block in the fourth row. As a result, when the initial position of candidate reference block for the fourth row is at position 0, the additional positions of candidate reference blocks are at a plurality of positions including position 3 (=0+3), position 6 (=0+(3×2), and position 9 (=0+(3×3) as shown in FIG. 22. In some embodiments, when the initial position of candidate reference block for the fourth row is at position 0, the additional positions of candidate reference blocks are at plurality of positions including position 3 (=0+3), position 6 (=position 3+3), and position 9 (=position 6+3) as shown in FIG. 22.

At 2462, in some embodiments, until the last row of the search region, the coder continuously determines positions of candidate reference blocks for each of subsequent rows based the offset, sampling interval, and an initial position of candidate reference block in a preceding row. For example, the coder determines an initial position of candidate reference block in last row based on the initial position of candidate reference block in previous row (last row−1) and the offset and determining additional positions of candidate reference blocks in the last row based on the initial position of candidate reference block in the last row and the sampling interval. As shown in FIG. 22, the positions of candidate reference blocks in the first row are repeated in the fourth row. In this example, the positions of candidate reference blocks in the first row are repeated in every fourth row. Likewise, the positions of candidate reference blocks in the second row are repeated in the fifth row. In this example, the positions of candidate reference blocks in the first row are repeated in every fifth row. Likewise, the positions of candidate reference blocks in the third row are repeated in the sixth row. In this example, the positions of candidate reference blocks in the third row are repeated in every sixth row.

FIG. 24C shows an example flowchart of method 2470 of arranging a plurality of positions of candidate reference blocks as shown in FIG. 23C, according to some embodiments of the present disclosure. The method 2470 may be performed by a coder (e.g., processing logic) that may include hardware (circuitry, dedicated logic, one or more processor, etc.), software (such as is run on a general purpose computer system or a dedicated machine), or a combination of both, which the coder may be included in any computer system or device. For simplicity of explanation, methods described herein are depicted and described as a series of operations. However, operations in accordance with this disclosure may occur in various orders and/or concurrently, and with other operations not presented and described herein. Further, not all illustrated operations may be used to implement the methods in accordance with the disclosed subject matter. In addition, those skilled in the art will understand and appreciate that the methods may alternatively be represented as a series of interrelated states via a state diagram or events. Additionally, the methods disclosed in this specification are capable of being stored on an article of manufacture, such as a non-transitory computer-readable medium, to facilitate transporting and transferring such methods to computing devices. The term article of manufacture, as used herein, is intended to encompass a computer program accessible from any computer-readable device or storage media. Although illustrated as discrete blocks, various blocks may be divided into additional blocks, combined into fewer blocks, or eliminated, depending on the desired implementation.

At 2472, for each search region, the coder determines rows (e.g., second row, third row, fourth row . . . last row) for positions of candidate reference blocks based on a determined first row (e.g., first row in FIG. 24A) and a sampling interval (shifting to the upper direction). For example, the coder determines the second row based on the first row+sampling interval of 3 samples in the vertical direction. In some embodiments, the coder determines the third row based on the second row+sampling interval of 3 samples. In some embodiments, the coder determines the third row based on the first row+(2×sampling interval of 3 samples). In some embodiments, the coder determines the fourth row based on the third row+sampling interval of 3 samples. In some embodiments, the coder determines the fourth row based on the first row+(3×sampling interval of 3 samples). As a result, for each search region, the coder selects rows that are N×sampling interval away in the upper direction from the determined first row (e.g., N=1 for the second row, N=2 for the third row, N=3 for the fourth row . . . ).

At 2474, for the first row, the coder determines additional positions of candidate reference blocks based on a determined initial position of candidate reference block in the first row (e.g., initial position of candidate reference block in FIG. 24A, predetermined position such as position 0, position 1, or position 2) and the sampling interval (shifting to the left direction). For example, the coder selects the additional positions of candidate reference blocks in the first row that are N×sampling interval away in the left direction from the initial position of candidate reference block in the first row. As a result, when the initial position of candidate reference block for the first row is at position 0, the additional positions of candidate reference blocks are at a plurality of positions including position 3 (=0+3), position 6 (=0+ (3×2)), and position 9=(0+(3×3) as shown in sixth TMP search region (R6) in FIG. 23C. In some embodiments, when the initial position of candidate reference block for the first row is at position 0, the additional positions of candidate reference blocks are at plurality of positions including position 3 (=0+3), position 6 (=position 3+3), and position 9 (=position 6+3) as shown in sixth TMP search region (R6) in FIG. 23C.

At 2476, for the second row, the coder determines positions of candidate reference blocks based on the positions of candidate reference blocks in the first row. For example, the coder determines the positions of candidate reference blocks at position 0, position 3, and position 6, position 9 for the second row.

At 2478, for the third row, the coder determines positions of candidate reference blocks based on the positions of candidate reference blocks in the first row or the second row. For example, the coder determines the positions of candidate reference blocks at position 0, position 3, and position 6, position 9 for the second row.

At 2480, for the fourth row, the coder determines positions of candidate reference blocks based on the positions of candidate reference blocks in the first row, the second row, or the third row. For example, the coder determines the positions of candidate reference blocks at position 0, position 3, and position 6, position 9 for the second row.

At 2482, for the last row, the coder determines positions of candidate reference blocks based on the positions of candidate reference blocks in the first row, the second row, the third row, the fourth row . . . or the last row−1. For example, the coder determines the positions of candidate reference blocks at position 0, position 3, and position 6, position 9 for the second row.

As shown, comparing with the method 2450 in FIG. 24B, the method 2470 in FIG. 24C requires less computation and easier to implement.

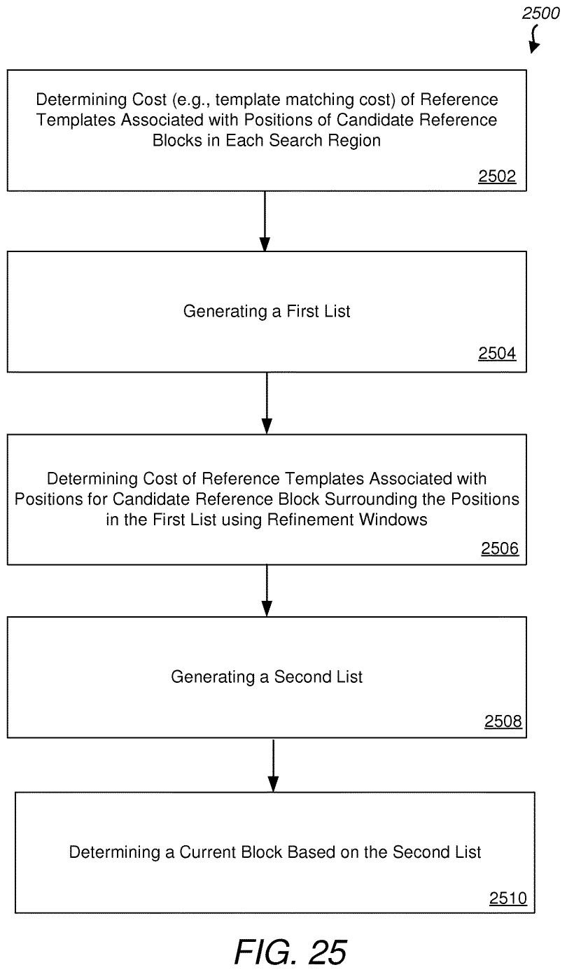

FIG. 25 shows an example flowchart of method 2500 of determining a current block, according to some embodiments. The method 2500 may be performed by a coder (e.g., processing logic) that may include hardware (circuitry, dedicated logic, one or more processor, etc.), software (such as is run on a general purpose computer system or a dedicated machine), or a combination of both, which the coder may be included in any computer system or device. For simplicity of explanation, methods described herein are depicted and described as a series of operations. However, operations in accordance with this disclosure may occur in various orders and/or concurrently, and with other operations not presented and described herein. Further, not all illustrated operations may be used to implement the methods in accordance with the disclosed subject matter. In addition, those skilled in the art will understand and appreciate that the methods may alternatively be represented as a series of interrelated states via a state diagram or events. Additionally, the methods disclosed in this specification are capable of being stored on an article of manufacture, such as a non-transitory computer-readable medium, to facilitate transporting and transferring such methods to computing devices. The term article of manufacture, as used herein, is intended to encompass a computer program accessible from any computer-readable device or storage media. Although illustrated as discrete blocks, various blocks may be divided into additional blocks, combined into fewer blocks, or eliminated, depending on the desired implementation.

At 2502, the coder determines a plurality of search regions relative to a current block. In some embodiments, the coder determines the plurality of positions of candidate reference blocks in one search region independent from other positions of candidate reference blocks in other search regions. In some embodiments, the coder determines the plurality of positions of candidate reference blocks such that the positions of candidate reference blocks are consistently spread over the plurality of search regions. In some embodiments, the coder determines cost (e.g., template matching cost) based on a current template and reference templates associated with the positions of candidate reference blocks in each search region. In an example, the cost may be based on a difference (e.g., sum of squared differences (SSD), sum of absolute differences (SAD), sum of absolute transformed differences (SATD), or difference determined based on a hash function) between template of a reference block (reference template) and template of current block (current template). For example, the coder determines 11 template matching costs for fourth TMP search region (R4) in FIG. 23B.

At 2504, the coder generates a first list based on costs determined above. In some embodiments, the first list includes 30 positions for candidate reference blocks (or 30 block vectors associated with the 30 positions) that provide the lowest costs. For example, the coder lists the 30 positions for candidate reference blocks (or 30 block vectors associated with the 30 positions) in a cost ascending order (from lowest cost to greatest cost). In some embodiments, the first list includes less than 30 positions for candidate reference blocks (or block vectors). In some embodiments, the first list includes more than 30 positions for candidate reference blocks (or block vectors).

In some embodiments, the coder predicts the current block based on the first list. For example, the coder selects the best candidate reference block with the lowest cost in the first list for predicting (e.g., generating) the current block. In some embodiments, the coder selects a number of candidate reference blocks with the lowest costs in the first list for predicting (e.g., generating) the current block. In some embodiments, for predicting the current block, the coder may perform fusion using SAD-based weights based on the selected candidate reference blocks in the first list. In some embodiments, for predicting the current block, the coder may perform fusion using Weiner-filter based on selected candidate reference blocks in the first list.

At 2506, the coder determines additional costs (e.g., template matching cost) based on the first list and refinement windows (e.g., 3×3 refinement window). As shown in FIG. 21, the coder determines the additional costs based on positions surrounding each position indicated in the first list.

At 2508, the coder generates a second list based on the costs associated with the positions in the first list and the additional costs determined based on the refinement windows. The coder determines the second list with the lowest costs. In some embodiments, the second list includes 19 positions for candidate reference block (or 19 block vectors associated with the 19 positions) that provides the lowest costs. In some embodiments, the second list includes less than 19 positions for candidate reference block (or block vectors associated with the 19 positions). In some embodiments, the second list includes more than 19 positions for candidate reference block (or block vectors). In some embodiments, the first list is greater than the second list.

At 2510, the coder determines (e.g., generates) the current block based on the second list. In some embodiments, the coder selects the best candidate reference block with the lowest cost in the second list for predicting (e.g., generating) the current block. In some embodiments, the coder selects a number of candidate reference blocks with the lowest costs in the second list for predicting (e.g., generating) the current block. In some embodiments, for predicting the current block, the coder may perform fusion using SAD-based weights based on the selected candidate reference blocks in the second list. In some embodiments, for predicting the current block, the coder may perform fusion using Weiner-filter based on selected candidate reference blocks in the second list.

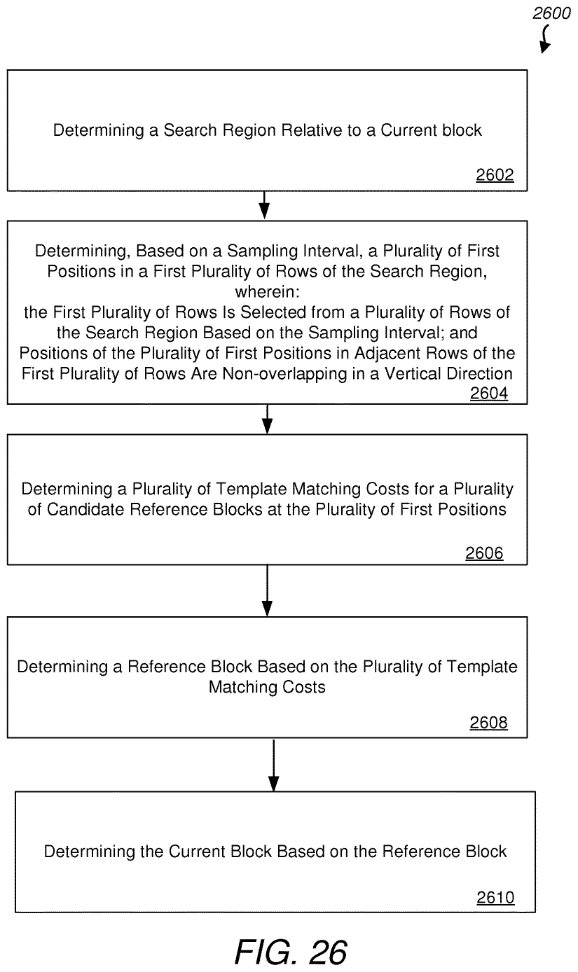

FIG. 26 shows an example flowchart of method 2600 of determining a current block, according to some embodiments. The method 2600 may be performed by a coder (e.g., processing logic) that may include hardware (circuitry, dedicated logic, one or more processor, etc.), software (such as is run on a general purpose computer system or a dedicated machine), or a combination of both, which the coder may be included in any computer system or device. For simplicity of explanation, methods described herein are depicted and described as a series of operations. However, operations in accordance with this disclosure may occur in various orders and/or concurrently, and with other operations not presented and described herein. Further, not all illustrated operations may be used to implement the methods in accordance with the disclosed subject matter. In addition, those skilled in the art will understand and appreciate that the methods may alternatively be represented as a series of interrelated states via a state diagram or events. Additionally, the methods disclosed in this specification are capable of being stored on an article of manufacture, such as a non-transitory computer-readable medium, to facilitate transporting and transferring such methods to computing devices. The term article of manufacture, as used herein, is intended to encompass a computer program accessible from any computer-readable device or storage media. Although illustrated as discrete blocks, various blocks may be divided into additional blocks, combined into fewer blocks, or eliminated, depending on the desired implementation.

At 2602, the coder determines a search region relative to a current block. For example, as shown in FIG. 18 and FIG. 22, the coder determines third TMP search region (R3) relative to the current block.

At 2604, the coder determines, based on a sampling interval, a plurality of first positions in a first plurality of rows of the search region. The first plurality of rows is selected from a plurality of rows of the search region based on the sampling interval and positions of the plurality of first positions in adjacent rows of the first plurality of rows are non-overlapping in a vertical direction. As shown in FIG. 22, positions of candidate reference blocks 2220 in adjacent rows are non-overlapping in the vertical direction. As a result, all of columns (e.g., column at position 0, column at position 1, column at position 2, column at position 3, column at position 4, column at position 5, column at position 6, column at position 7, column at position 8, column at position 9, column at position 10), have at least one position of candidate reference block 2220—improving sampling diversity.

At 2606, the coder determines a plurality of template matching costs for a plurality of candidate reference blocks at the plurality of first positions.

At 2608, the coder determines a reference block based on the plurality of template matching costs. In some embodiments, the coder determines a reference block with the lowest template matching cost.

At 2610, the coder determines the current block based on the reference block.

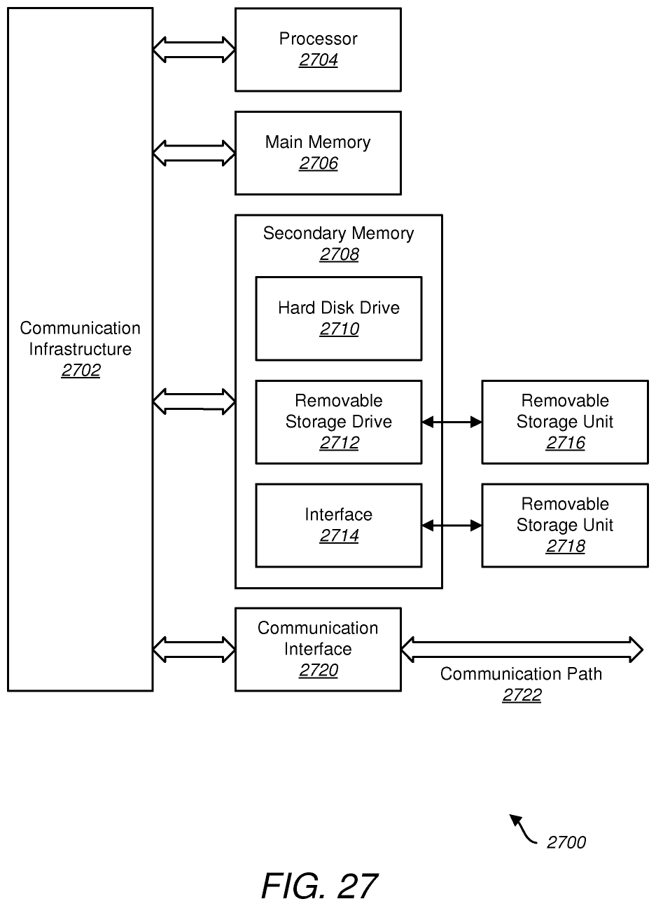

Embodiments of the present disclosure may be implemented in hardware using analog and/or digital circuits, in software, through the execution of instructions by one or more general purpose or special-purpose processors, or as a combination of hardware and software. Consequently, embodiments of the disclosure may be implemented in the environment of a computer system or other processing system. An example of such a computer system 2700 is shown in FIG. 27. Blocks depicted in the figures above, such as the blocks in FIGS. 1, 2, and 3, may execute on one or more computer systems 2700. Furthermore, each of the steps of the flowcharts depicted in this disclosure may be implemented on one or more computer systems 2700.

Computer system 2700 includes one or more processors, such as processor 2704. Processor 2704 may be, for example, a special purpose processor, general purpose processor, microprocessor, or digital signal processor. Processor 2704 may be connected to a communication infrastructure 2702 (for example, a bus or network). Computer system 2700 may also include a main memory 2706, such as random access memory (RAM), and may also include a secondary memory 2708.

Secondary memory 2708 may include, for example, a hard disk drive 2710 and/or a removable storage drive 2712, representing a magnetic tape drive, an optical disk drive, or the like. Removable storage drive 2712 may read from and/or write to a removable storage unit 2716 in a well-known manner. Removable storage unit 2716 represents a magnetic tape, optical disk, or the like, which is read by and written to by removable storage drive 2712. As will be appreciated by persons skilled in the relevant art(s), removable storage unit 2716 includes a computer usable storage medium having stored therein computer software and/or data.

In alternative implementations, secondary memory 2708 may include other similar means for allowing computer programs or other instructions to be loaded into computer system 2700. Such means may include, for example, a removable storage unit 2718 and an interface 2714. Examples of such means may include a program cartridge and cartridge interface (such as that found in video game devices), a removable memory chip (such as an EPROM or PROM) and associated socket, a thumb drive and USB port, and other removable storage units 2718 and interfaces 2714 which allow software and data to be transferred from removable storage unit 2718 to computer system 2700.

Computer system 2700 may also include a communications interface 2720. Communications interface 2720 allows software and data to be transferred between computer system 2700 and external devices. Examples of communications interface 2720 may include a modem, a network interface (such as an Ethernet card), a communications port, etc. Software and data transferred via communications interface 2720 are in the form of signals which may be electronic, electromagnetic, optical, or other signals capable of being received by communications interface 2720. These signals are provided to communications interface 2720 via a communications path 2722. Communications path 2722 carries signals and may be implemented using wire or cable, fiber optics, a phone line, a cellular phone link, an RF link, and other communications channels.

As used herein, the terms “computer program medium” and “computer readable medium” are used to refer to tangible storage media, such as removable storage units 2716 and 2718 or a hard disk installed in hard disk drive 2710. These computer program products are means for providing software to computer system 2700. Computer programs (also called computer control logic) may be stored in main memory 2706 and/or secondary memory 2708. Computer programs may also be received via communications interface 2720. Such computer programs, when executed, enable the computer system 2700 to implement the present disclosure as discussed herein. In particular, the computer programs, when executed, enable processor 2704 to implement the processes of the present disclosure, such as any of the methods described herein. Accordingly, such computer programs represent controllers of the computer system 2700.

In another embodiment, features of the disclosure may be implemented in hardware using, for example, hardware components such as application-specific integrated circuits (ASICs) and gate arrays. Implementation of a hardware state machine to perform the functions described herein will also be apparent to persons skilled in the art.

What is claimed is:

1. A method comprising:
determining a search region (SR) relative to a current block;
determining, based on a sampling interval, a plurality of sampling positions in a plurality of sampling rows of the search region, wherein sampling positions of the plurality of sampling positions in two adjacent sampling rows of the plurality of sampling rows are in different columns of the search region;
determining a plurality of template matching costs for a plurality of respective candidate reference blocks (RBs) at the plurality of respective sampling positions;
determining an RB based on the plurality of template matching costs; and
determining a prediction block of the current block based on the RB.

2. The method of claim 1, wherein the determining the SR is based on an indication of template matching prediction (TMP) for coding the current block.

3. The method of claim 1, wherein the search region is a sub-region of a plurality of sub-regions for the current block.

4. The method of claim 1, wherein the determining, based on the sampling interval, the plurality of sampling positions in a plurality of sampling rows of the search region comprises:
determining a first initial sampling position in a first row of the plurality of sampling rows; and
determining an additional sampling position in the first row based on the sampling interval and the first initial sampling position in the first row.

5. The method of claim 4, further comprising:
determining a second initial sampling position in a second row of the plurality of sampling rows based on the first initial sampling position and an offset.

6. The method of claim 5, further comprising:
determining an additional sampling position in the second row based on the sampling interval and the second initial sampling position in the second row.

7. The method of claim 1, wherein the search region comprises a plurality of sub-regions for the current block.

8. An apparatus, comprising:
one or more processors; and
memory storing instructions that, when executed by the one or more processors, cause the apparatus to:
determine a search region (SR) relative to a current block;
determine, based on a sampling interval, a plurality of sampling positions in a plurality of sampling rows of the search region, wherein sampling positions of the plurality of sampling positions in two adjacent sampling rows of the plurality of sampling rows are in different columns of the search region;
determine a plurality of template matching costs for a plurality of respective candidate reference blocks (RBs) at the plurality of respective sampling positions;
determine an RB based on the plurality of template matching costs; and
determine a prediction block of the current block based on the RB.

9. The apparatus of claim 8, wherein the determining the SR is based on an indication of template matching prediction (TMP) for coding the current block.

10. The apparatus of claim 8, wherein the search region is a sub-region of a plurality of sub-regions for the current block.

11. The apparatus of claim 8, wherein the determining, based on the sampling interval, the plurality of sampling positions in a plurality of sampling rows of the search region comprises:
determining a first initial sampling position in a first row of the plurality of sampling rows; and
determining an additional sampling position in the first row based on the sampling interval and the first initial sampling position in the first row.

12. The apparatus of claim 11, wherein the instructions, when executed by the one or more processors, further cause the apparatus to:
determine a second initial sampling position in a second row of the plurality of sampling rows based on the first initial sampling position and an offset.

13. The apparatus of claim 12, wherein the instructions, when executed by the one or more processors, further cause the apparatus to:
determine an additional sampling position in the second row based on the sampling interval and the second initial sampling position in the second row.

14. The apparatus of claim 8, wherein the search region comprises a plurality of sub-regions for the current block.

15. A non-transitory computer-readable medium comprising instructions that, when executed by one or more processors of an apparatus, cause the apparatus to:
one or more processors; and
memory storing instructions that, when executed by the one or more processors, cause the apparatus to:
determine a search region (SR) relative to a current block;
determine, based on a sampling interval, a plurality of sampling positions in a plurality of sampling rows of the search region, wherein sampling positions of the plurality of sampling positions in two adjacent sampling rows of the plurality of sampling rows are in different columns of the search region;
determine a plurality of template matching costs for a plurality of respective candidate reference blocks (RBs) at the plurality of respective sampling positions;
determine an RB based on the plurality of template matching costs; and
determine a prediction block of the current block based on the RB.

16. The non-transitory computer-readable medium of claim 15, wherein the determining the SR is based on an indication of template matching prediction (TMP) for coding the current block.

17. The non-transitory computer-readable medium of claim 15, wherein the search region is a sub-region of a plurality of sub-regions for the current block.

18. The non-transitory computer-readable medium of claim 15, wherein the determining, based on the sampling interval, the plurality of sampling positions in a plurality of sampling rows of the search region comprises:
determining a first initial sampling position in a first row of the plurality of sampling rows; and
determining an additional sampling position in the first row based on the sampling interval and the first initial sampling position in the first row.

19. The non-transitory computer-readable medium of claim 18, wherein the instructions, when executed by the one or more processors, further cause the apparatus to:
determine a second initial sampling position in a second row of the plurality of sampling rows based on the first initial sampling position and an offset.

20. The non-transitory computer-readable medium of claim 15, wherein the search region comprises a plurality of sub-regions for the current block.
